(19) United States
(12) Patent Application Publication
(10) Pub. No.: US 2006/0177796 A9
(43) Pub. Date: Aug. 10, 2006

(54) Rubber Dams With Operative Inserts Which Isolate Anatomical Structures by Effectively Resisting External Vector Forces of Displacement

(76) Inventor: John Martin Heasley, Iowa City, IA (US)

Correspondence Address: JOHN M. HEASLEY, 1614 Dover Street, IOWA CITY, IA, 52240, US

(21) Appl. No.: 10/117,395

(22) Filed: Apr. 5, 2002

Related U.S. Application Data
(60) Provisional application No. 60/281,862, filed on Apr. 5, 2001.

(51) Int. Cl. A61C 5/14

(52) U.S. Cl. 433/136; 433/138

(57) ABSTRACT

A general field isolation rubber dam with particular applicability in the field of dentistry. An operative insert, in the form of a wire, stamping, or the like, is embedded in or applied to a sheet of elastomeric material such as is used in conventional rubber dams. The operative insert may be elastic, malleable, resilient and deformable or rigid. The operative insert is usually in the form of a closed loop and an opening or openings for defining an operative field is created in the rubber dam material interiorly of the closed loop. The operative insert assists in isolating tensile forces in the rubber dam membrane outside of the insert from distorting the general field isolation dam adjacent the operative field.

### BACKGROUND OF THE INVENTION

The invention relates generally general field isolation rubber dams and more particularly to rubber dams used for the purpose of isolating portions of the oral cavity in order to retract tissues, control moisture, and maintain a dry field during dental treatment.

Dr. Sanford C. Barnum, of New York, invented the original rubber dam in 1864. It was instantly recognized and accepted as the first really effective isolation modality, which fulfilled the dentists' need to work in a dry operating field. The use of the rubber dam in dentistry has been continuous since that time, and its use has become accepted as the ‘gold standard’ of isolation of the oral cavity for dental treatment purposes throughout the world dental community. The techniques of dental rubber dam application are taught universally in dental schools both in the United States and abroad as the highest modality of operational site isolation in dentistry. Although the use of the rubber dam in dentistry is highly efficacious, some limitations in the design of the rubber dam membrane, and difficulties in the practical application of the rubber dam in clinical practice, limit the range of dental procedures, which may be accomplished with its use, and have caused an attrition rate in clinical practice, which is considerable. It is estimated that although all dentists are trained in the use of the rubber dam in dental school, in private practice only about 10% of practicing dentists regularly use the device. The principal reasons cited for this high attrition rate are difficulty of application and discomfort to the patient.

The rubber dam devices described in this patent disclosure are the direct descendants of the prior art of operational site isolation with the rubber dam. They are not barrier drapes. These general field isolation rubber dam devices are meant to extend the range of the conventional rubber dam, and operate side-by-side with this effective modality of operational site isolation technique. They are also meant to make the rubber dam easier to use and more comfortable to the patient, and therefore encourage the majority of practicing dentists to begin or return to their use of the rubber dam as a universally practiced adjunct to dental clinical practice.

The most important defining difference between the dental rubber dam and the barrier drape is that the dental rubber dam is actively stretched over anatomical structures, thereby creating internal tensile stresses which interact with and serve to actively retract anatomical soft tissues. The barrier drape, on the other hand, is draped passively over the anatomical structures of the mouth or the portion of the anatomy that is to be isolated, thereby not creating internal stresses, and subsequently not actively retracting anatomical tissues. The dental rubber dam is generally a flat sheet of resilient material, which changes in shape to its operational contours by an active interaction with the tissues that it is stretched over; while the dental barrier drape is precontoured to the curvatures of the oral cavity, thus attempting to mimic those contours of the tissues that it seeks to isolate so that it might be draped passively over them. The actively stretched rubber dam takes up all the excess material of the rubber dam membrane, diverting it to the outside of the mouth wherever possible, so that it does not obstruct the tongue and throat of the patient. The dental barrier drape does not have this action, and thereby allows the excess material of the drape to flop around the oral cavity under the action of the tongue, thereby annoying the operating personnel during the course of clinical treatment, and to reflexively gag or choke the patient in the process.

The rubber dam, stretched from the intra-oral operative site to an external framework, creates a funnel-shaped barrier configuration, which, when the patient is in the supine position as all modern dental procedures are performed, actively directs the drainage and flow of fluids to a focal point, where an assistant can suction them out of the operative field. The barrier drape does not focus the flow of fluids, but allows fluids to pool in dispersed locations, thereby complicating their removal. In addition, the tensile forces created by the stretching of the rubber dam gently coax the patient into keeping his mouth open during the process of reflexive swallowing during a procedure, thereby preventing the patient from closing his mouth and interrupting the dentist and auxiliary personnel during clinical treatment. Finally, the stretching of the rubber dam over an external framework creates internal tensile stresses, which retract the patient's lips, tongue, and cheeks, thereby exposing the operative site for maximal access for instrumentation. The dental barrier drape does not rely on the membrane itself to accomplish this, since no stretching and tensile forces are generated. Instead, it relies on an ineffective spring-like mouth prop device to replace these functions, while wholly ignoring the need for adequate retraction of the patient's lips to gain access to the working site.

Two prior art devices cited in the prior art are illustrative of the difference between a true rubber and the inraoral barrier drape concept. The first is U.S. Pat. No. 5,078,604, which makes no pretensions about the device being a rubber dam, and instead describes it as a barrier drape, which it is because it lies passively over the intra-oral tissues in an attempt to avoid any stretching and the creation of internal stresses. The patent goes to great lengths to point out what are alleged to be the deficiencies of the rubber dam, foremost of which are the internal tensile stresses which a stretched membrane generates. The proposed solution is a concave ‘bag shaped’ barrier drape which is pre-contoured to all of the anatomical irregularities of the oral cavity; a drape which lies passively over all of the tissues of the oral cavity and generates no internal stresses by stretching. The patent ignores the fact that each and every patient has a different anatomic configuration, and that it is impossible to create a drape that satisfies every anatomy. It also ignores the fact that excess barrier material, if it protrudes too far back into a patient's mouth, will cause the patient to gag and choke, causing not only discomfort to the patient, but an interruption of the clinical treatment needs, let alone a wholesale failure of the device clinically. It also ignores the tact that while a barrier drape may be fine if it is draped over a leg or other external body part, the same device applied intra-orally must contend with the patient's tongue, which moves and protrudes constantly, thus causing a loose barrier drape to flop all over the oral cavity and obstruct the dental surgeon's activities. It also ignores the fact that without the internal tension of a true rubber dam membrane, the lips and cheeks are not retracted; nor is the patient's mouth gently coaxed open to give access to the operative site for instrumentation. Instead, it proposes that auxiliary devices be applied to achieve these ends, rather than the action of the membrane.

The second device illustrative of the difference between a true rubber dam and an intra-oral barrier drape, is a German device which purports to be a rubber dam (cofferdam in the German language), but really is a barrier drape in disguise and is described in European Patent No. EP1006925AI (Horvath et al.). This is not a flat membrane, like a true rubber dam. Instead, it is described as “bag shaped . . . so that it fits easily into the oral cavity.” It is said to be “a rubber dam which is rolled up at its front end”, but by unrolling it, the bag shape of the dam can be protruded. Effectively, the concept is one of an oral prophylactic which comes from the factory rolled up like a condom, but after unrolling, a tubular or generally closed ended cylindrical membrane is exposed. The resultant membrane is then stuffed back into the oral cavity and throat of the patient in an attempt to provide a barrier. The problems with this concept are gagging and choking of the patient by excess membrane material, flopping around of the excess material by the actions of the patient's tongue, lack of retraction of the lips and cheeks, and a lack of the mouth being gently propped open by the membrane.

U.S. Pat. No. 5,078,604 is exemplary of the design deficiencies of a barrier drape, particularly in the manner in which it allows excess barrier material to encroach on the patient's internal oral cavity, almost to the soft palate and the oropharynx. Two additional devices, each purporting to be clinically useful rubber dam devices, however, mimic the shortcomings of the '604 patent. They are U.S. Pat. No. 4,000,387, and German Patent No. DE19704904C. These three devices have design shortcomings that are almost identical. All three purport to be able to isolate either an entire arch of teeth or both the whole upper and lower arches of teeth at the same time. All three are flat plane devices, which effectively fold in a simple hinge action down the middle. All three are designed to create a barrier membrane type of approach to isolating the oral cavity for dental treatment. All three have a solid oval shaped central membrane interior of the structures to isolate the teeth. All three are interarch devices; that is, that they have an action not only within a single arch of teeth, but between both the upper and the lower arch of teeth. There are some difference between the devices, such as the fact that the '387 patent needs to be snapped together with a rubber dam membrane between two parts to create the full membrane, while the European Patent design is attached already to the membrane.

It should be noted that the internal framework design of the European Patent is identical to the flat plane design of the '387 patent, except for the fact that the '387 device is snapped over a piece of rubber dam material, while the European device is “attached” to a piece of rubber dam material. Both the devices, subsequently, show the exact same design flaws that have been aforementioned.

The first deficiency of these devices is that they all act in a simple hinge type of opening or closure. This would be fine, if the maxillary and mandibular alveolar arches pivoted with respect to each other about an axis located less than an inch behind the last tooth in each arch. They do not. Instead the occlusal planes of the upper and lower teeth disclude in almost a parallel manner upon mandibular opening (actually, a very slight arcuate manner), for the first two to three cm., before the mandible begins a forward translatory movement with wider opening. The real hinge-type joint, the mandibular condyle articulating with the glenoid fossa. is located 4-5 inches away. Any barrier drape or rubber dam device designed for a simple hinge type of opening mechanism tails to satisfy the anatomical needs that it seeks to satisfy.

The second major drawback of these three devices is that each has a solid planar oval membrane of barrier material central to the structures attempting to isolate the teeth. Upon folding in the simple hinge action described above, and insertion way back into the oral cavity to accommodate the isolation of a whole arch (or whole arches), this barrier material is carried back into the patient s oral cavity, providing an encroachment upon the tongue and oropharynx. This causes gagging, choking, a feeling of claustrophobia, discomfort to the patient, and an interruption of the dentist and his auxiliaries.

All three of these devices fold in a simple hinge type of closure. They all lack a component of design which accommodates the interocclusal distance between the maxillary and mandibular teeth when the patient's mouth is partially or filly opened. They embody solutions which fail to take into account human anatomy, which is the ultimate criterion for the interaction of a prosthesis with a complementary interface. These devices assume that the mandibular and maxillary teeth pivot about an axis of rotation which is located within a centimeter behind the last molar in the arch. In actual reality, the mandibular and maxillary teeth separate in almost parallel planes with respect to their occlusal surfaces. There is some arcuate disclusion, but the center axis Of the rotation of the mandible with respect to the maxilla is the temporomandibular joint, which is located at least four to six inches away from the occlusal surfaces of the teeth. Interocclusal distance in a partial or fully discluded mandibular opening may vary from patient to patient, due to anatomical size, or may vary with the degree of opening which a volitional act of the patient. The actual dimensions may vary, so an exact or precise dimensional criterion for incorporation into an appliance may also vary, but there is some room for compensation of whatever dimensional value is incorporated into the appliance, by instructing the patient to go into a partial or extended state of closure. One statement that may be made with respect to interocclusal distance and the design of a general field isolation rubber dam appliance is that interocclusal distance is directly proportional to the radius of measurement of opening of the teeth in a posterior to anterior direction.

If whole arch, reciprocal isolation is to be attempted with a rubber dam, the specialized design of the rubber dam must make allowance for the integrity of the patient's interior oral cavity and structures, such as the tongue and periodic swallowing reflexes. The specialized design of a whole arch rubber dam, which will find a market primarily in orthodontics, must have a number of critical design features that many of the other rubber dams do not have, but the need to address the design deficiencies of these prior art devices is paramount to the creation of a successful whole arch isolation device.

In the conventional technique of rubber dam usage, the dental practitioner perforates the thin, flat sheet of rubber dam material with a series of holes corresponding to the number and configuration of teeth to be isolated within a proposed operative site. The perforated rubber dam is then inserted into the patient's mouth, and the perforations are stretched over individual teeth sequentially until the entire operating site is exposed. This technique exposes the clinical crowns of the teeth only (the visible portion of the teeth above the gumline), which restricts the dentist primarily to procedures associated with the hard structures of the teeth above the gumline. Because of this, prosthetic procedures in particular have been universally performed without the use of a rubber dam since they require instrumentation below the gumline for their completion. In order to prepare a tooth for a crown or an abutment for a bridge, exposure of both the visible portion of a tooth and some portion of the gingival soft tissues (the gums) is essential. With a modified rubber dam membrane, which fulfills this need, a dentist or prosthodontist can remove tooth material above and below the free marginal gingiva (the gumline), then pack retraction cord into the gingival sulcus (the space between the tooth and the gum), to prepare for taking impressions of the tooth or teeth for which the crown or bridge is to be made. The taking of an impression of the prepared tooth is necessary for a mold to be made of the teeth in order for a dental laboratory to later construct a crown or bridge to be seated over the prepared tooth or teeth. Currently, almost all prosthetic procedures are universally performed without the use of a rubber dam due to limitations inherent in the methods, techniques, and materials available in the conventional rubber dam usage.

The term intra-alveolar space for the purposes of this disclsure is defined as the three dimensional concavity enclosed within and bordered by the confines of the alveolar arches, the hard and soft palate, the lingual floor, and the posterior oropharynx. The alveolar aches are composed of all hard and soft tissues which make up the dentition: the alveolar bone, gingival tissues, teeth, and the periodontal ligamental attachment apparatus. The intra-alveolar space might also be termed the lingual space, for it is occupied principally by and accommodates movements of the patient's tongue. Near the posterior boundaries of this concave anatomical structure is the soft palate, which is an important structure for the design of field isolation rubber dam appliances, for this is the locus of the origination of the patient's gag reflex. Any device which fails to take into account in its design and significantly violates the intra-alveolar space is doomed to failure clinically and commercially, because it will not be tolerated by the patient. The result will be discomfort to the patient, gagging and choking, a constant interruption of the clinical procedure, and ultimately a failure of the device clinically.

All three of the prior art rubber dam or barrier drape isolation devices previously mentioned, the '387 patent, the '604 patent, and the German Patent No. DE19704904C, fail to address the need for the integrity of the intra-alveolar space in their designs. All three fold in a simple hinge-axis manner, carrying rubber dam or barrier material far back into the throat of the patient, thus violating the integrity of this space and resulting in an action which would cause the patient to gag and choke and ultimately cause the devices to be failures clinically. This design flaw is also the principal reason for the failure of any intra-oral barrier drape device which allows excess barrier material to floatloosely within this space. The whole arch general field isolation rubber dam devices of the present invention overcome this design flaw, allowing for a concavity to be formed to accommodate the intra-alveolar space. The whole arch field isolation rubber dam must have this design feature in order to be clinically efficacious and commercially successful. It needs to be said that some intrusion into the intra-alveolar space is tolerable by the patient. After all, the conventional rubber dam does involve the placing of rubber dam material into the oral cavity. The distinction of what the patient is able to tolerate and what he or she cannot accommodate is a matter of the degree of the amount of intrusion of the rubber dam or barrier device. A whole arch isolation technique that goes way back into the space must have the concave diaphragm, but an isolation device which only seeks to isolate the anterior half of the alveolar arch generally will afford the patient enough space within the intra-alveolar space to accommodate his tongue and also will avoid the reflexive gag response. All people are quite individual, however, so individual variability will have an overall effect. The anterior half arch field isolation rubber dam, for the reasons stated, may be commercially fabricated without an inner concave diaphragm, and still be a clinically efficacious modality of field isolation. Of course, this same dam could also be fabricated with an interior concave diaphragm. Any field isolation rubber dams or intra-oral rubber dam devices designed for isolating a portion of the alveolar arch from the half arch configuration described or anterior to this, isolating just the anterior segment or even fewer teeth in the arch may be fabricated without the interior concave diaphragm. The isolation of bilateral arch segments between the posterior boundary of the half arch and the whole alveolar arch, is a gray area, where ever increasing posterior placement of a field isolation rubber dam must be accompanied by the interior diaphragm in order to be successful. While some circumstances may allow the flat form membrane to be fabricated in these intermediate areas, this author favors the concave diaphragm in these circumstances.

The unilateral general field isolation rubber dams do not pose the same problems of intolerable intrusion into the intra-alveolar space that the whole arch reciprocally retained field isolation appliances do. The reason for this is that isolation is only on one side of the mouth, and the action of the rubber dam frame in stretching the excess rubber dam material draws the excess material out of the alveolar space, creating room for the tongue and internal structures to be accommodated. The resultant form of the three dimensionally stretched unilaterally retained field -isolation rubber dam is roughly an irregular pyramidal shape, which interacts with the intra-alveolar space in a generally acceptable manner.

The prior art general field isolation devices have not addressed the isolation of the alveolar arch in a manner in which an effective and stable moisture impervious operative perimeter is formed. The overall goal of isolating both the teeth and their associated soft tissues of the alveolar arch simultaneously, is to both expose these structures effectively and at the same time create an effective operative perimeter with an impervious moisture seal. All of the prior art devices fall short of this goal. Two devices which are rudimentary attempts at simple retraction of the rubber dam membrane in order to isolate a site are U.S. Pat. No. 5,503,556, and the Canadian product, Bond Buddy. Each of these devices are identical in the manner in which they retract a rubber dam membrane, so a comparison for one is applicable to the other. For the purposes of analysis, if the vector form of retraction of the rubber dam membrane with respect to the alveolar arch is broken down into vector components with “X” and “Y” components, and a retractive force in the X direction is defined as away from the tissues of the alveolar arch, and a retractive force in the Y direction is in a cervical direction (downward or toward the root ), then a force in the X direction pulling the rubber dam away from the tissues and subsequently leaving a gap is an undesirable design component, while a force which eliminates an X component while retracting in a cervical direction or Y direction, is generally desirable. Each of these devices exclusively retract the rubber membrane in an X direction, creating an open gap which will cause saliva and fluids to percolate through the membrane. Each of these devices is coplanar with their clamping action, which means that they retract the rubber dam membrane in a plane which is flush with the clamp which is applied at the gumline. Hence, there is no Y component of retraction. The '556 apparatus, used clinically, places the steel of the extensions of the clamp in direct proximity to the action of the cutting bun. A clinician does not have adequate access to prepare the margins of a crown and may wind up nicking or cutting through the stainless steel wings of the clamp. The field isolation rubber dam clamps described herein, whether used with the slit-dam technique or with the specially prepared field isolation rubber dam membranes, eliminate or minimize the X vector component of retraction, while effectively retracting primarily in a Y component direction. The retraction of the membrane is not an “all or none” approach to retracting only the edges of the membrane, but rather, the retraction is focused the edges of the rubber dam membrane to close-in on the alveolar arch in order to eliminate any open gaps in the tissue-dam interface. This feature allows for variable retraction of the membrane, either by frictional forces of the membrane stretched against the retraction clamp, or by the inclusion of nibs or tabs which grab the stretched membrane material.

Some prior art field isolation rubber dam devices have included integral mechanisms to control the rubber dam membrane with respect to isolating a site, but all fall short of an effective design of components which achieve this. The '387 patent, besides having the defects of hinge action and violation of the intra-alveolar space, shows a slit to isolate an arch of teeth. This device and also its counterpart, the Horvath whole arch appliance, allow for the isolation of the teeth only, but do not have mechanisms for the effective retraction of the rubber dam membrane below the gumline. The '604 patent, besides the design defects associated with the concept of an intra-oral barrier drape, talks of cutting out of rubber dam material, and of adapting the membrane to the alveolar arches, but not of controlling an operative perimeter while reciting the tensile forces of a stretched rubber dam, since this device seeks to eliminate all internal tensile forces and stretching. This device is not a true rubber dam, but is included for the sake of an analysis of the prior art. The intra-arch design of Horvath includes two plastically deformable elements with two elastically deformable elements arranged around a square pattern. The inventor supplements the inadequacies of his design with the use of adhesives. The lack of four fundamental elements of the design of the general field isolation rubber dams of the present invention, which are primarily all rigidly linked malleable components to form a completely three dimensional moldable operative perimeter, make the Horvath design an inadequate solution to the problems of general field isolation. Even in the few circumstances where limited discontinuous malleable elements may be used to retract the rubber dam membrane in this context, there is no need for two intervening elastic elements to be added. The use of adhesives to retain a rubber dam membrane has only a very limited applicability for the reason that intra-oral mucosal adhesives are not retentive enough to bond to the epithelium of the gingival or mucosal tissues with enough strength to resist the full forces of the stretched rubber dam membrane. In a few circumstances, intra-oral mucosal adhesives may be used for retention only, but this is only in anterior isolation cases where the largest forces are opposed by the field isolation rubber dam clamps which are a part of this disclosure. The continuous malleable operative perimeters of the present invention are sufficiently effective at forming an operative perimeter and resisting forces that they may be used wholly without the use of adhesives at all. Alternatively, barrier adhesives may be used for perfecting the moisture seal only, without any need for additional retention.

Attempts to achieve a moisture proof seal with the rubber dam in cases where gaps or leaks occur in its application, or in cases where the rubber dam has torn during a procedure, have been reported widely in the literature. In such situations these leaks or gaps have been sealed with the use of such commonly used materials as Cavit, Tempak, or even periodontal pack material. Orabase, produced by Colgate-Hoyt Laboratories has been found to be useful for sealing large holes when bonded to a rubber dam with rubber base adhesive. Attempts to isolate teeth so severely broken down by the carious process with the use of the conventional rubber dam have been attempted by using the large hole technique or the slit-dam technique of punching a series of holes in a conventional rubber dam with a rubber dam punch, then cutting the interseptal rubber between the holes with a scissors to form a slit in the dam. A patch of Orabase is then applied directly to the soft mucosal tissues around the badly broken down tooth, and then the Orabase is sealed to the slit in the rubber dam with rubber base adhesive. This technique is described in the Journal of Endodontics 1986. 12: 363-367, Solving isolation problems with rubber base adhesive, Bramwell, J. D., and Hicks, M. L.

A specific formulation for the syringeable application of polydimethylsiloxane as a putty caulk, sealing, or barrier material to plug leaks or gaps in a rubber dam or to repair tears in a rubber dam or to isolate tissue are described in U.S. Pat. No. 5,098,299. This composition patent specifies a formulation and makes mention to isolating tissue, but makes no mention of modifications of the rubber dam design or technique. Another formulation patent assigned to the same company, U.S. Pat. No. 6,086,370, describes a polymerizable isolation barrier which is applied with a syringe to form a coating of material in, around, or on teeth or gingival tissues to protect tissues from chemical irritation during treatment or to plug holes or gaps in leaky rubber dams. This patent is limited to the formulation described and claims to eliminate the need for the rubber dam altogether. It is supplied as a syringeable paste.

U.S. Pat. No. 5,803,734 describes a round button of thermoplastic material which is heated to a plastic state and linked to dental tissues or a rubber dam with an oral adhesive to either cushion a rubber dam clamp from damaging gingival tissues, or anchor a rubber dam to tissues, or to isolate tissues in a manner identical to the use of Orabase and rubber base adhesive with the conventional rubber dam and the slit-dam technique. No modification of the rubber dam design or integral change in the manner of application of the rubber dam is mentioned.

Dr. William H. Liebenberg, in the Compendium of Continuing Education in Dentistry, Vol. 19 (10):1028-1032, “Dental Dam Patch an Effective Intra-oral Repair Technique”, describes the use of cyanoacrylates in repairing the rubber dam and in bonding of the rubber dam to soft tissues with cyanoacrylates as a barrier material.

Various clamps and devices to retract the rubber dam from the work site have been introduced into the prior art. These retraction devices generally are used with the slit-dam technique of modifying the conventional rubber dam by cutting a slit in the dam with a sissors, then applying the clamp to the teeth to be isolated and stretching the rubber dam over the clamp or device to retract the rubber.

One such device, described in U.S. Pat. No. 5,503,556, describes an extended rubber dam clamp which is clamped onto a tooth behind a badly broken down tooth, then the rubber dam prepared and stretched over the teeth to be isolated and the clamp extensions retracting the rubber around the area to be isolated. Another almost identical clamp is currently marketed as the Silker & Glickman Clamp and Method of using the extended clamp with a slit-technique alternative rubber dam technique of stretching the rubber over the extensions on the clamp. Still another product, Bond Buddy, uses a plastic retraction framework in conjunction with a conventional rubber dam clamp to retract the rubber dam using the slit-dam technique in the same manner as the aforementioned clamps.

The Rubber Dam Retaining Device: Adjunct to isolation during placement of multiple veeners, by William H. Liebenberg Quintessence International 1995; 26:493-500, describes an appliance prepared to the specifications of the author and fabricated in a dental lab to isolate an anterior segment of teeth for the preparation of laminate veneers. A rubber dam is cut, using the slit-dam method and glued to the appliance to create a field-assembled device to isolate teeth to prepare and seat porcelain veneer restorations.

In another article by William Liebenberg, Extending the Use of the Rubber Dam, Part 1; Quintessence International 1992:23:657-665, Liebenberg describes a practice of placing rubber dam retainers(clamps) in a forward and backward position to isolate an intermediate tooth for the purpose of preparing a cast post during prosthetic procedures. The rubber dam is stretched over the two clamps which shield the intermediate tooth for subgingival instrumentation.

U.S. Pat. No. 6,093,022 describes the use of an adhesive and elevated portions in a rubber dam to replace the rubber dam clamp when securing the rubber dam in the mouth. The rubber dam application described is a conventional approach where holes are punched and the dam slipped over individual teeth individually. There is no mention of any alternative application of the rubber dam. The only function of the improvement is to replace the traditional rubber dam clamp. The retention of the adhesive is to adhere to one tooth only, not to retain the whole dam.

In addition, there is no use of the adhesive to act as a barrier material to seal the dam. U.S. Pat. No. 4,600,387 describes a plastic frame that a rubber dam sheet is disposed between to snap together, providing a framework to produce a dam assembly. The dam sheet can be cut or punched to isolate one or more teeth. No mention is made of the frame allowing the isolation of soft tissues at the time of isolation of the teeth. The planar design would not allow isolation of anything below the gumline, and would not even allow exposure of all teeth if third molars were erupted, blocking the distal portion of the framework from seating properly to the level of the gumline. The rigidity of the plastic frame and the “one size and configuration fits all” concept disqualifies this device as an effective form of isolation of the dentition.

There are an abundance of procedures and circumstances in all areas of dentistry that are applicable to the general field isolation rubber dam technique. First it must be stated, however, that although the conventional rubber dam technique is of immense benefit to a diversity of dental procedures and is taught universally in colleges of dentistry, only about 10% of dentists routinely use the rubber dam in clinical practice. The other 90% of practicing dentists disregard it altogether or practice with it only selectively, but ironically are constantly looking for another isolation device or method that will replace it or will come even moderately close to its benefits. Probably the most apt commentary about the discouraging statistics of the lack of use of the rubber dam was made by J. M. Prime in the Journal of Dentistry, Vol 7: 197-198 in 1938: “Probably no other technique, instrument, or treatment in dentistry has been more universally accepted and advocated, and yet is so universally ignored by practicing dentists.” There seems to be an inverse relationship between the degree of regularity of use of this isolation device and the degree of difficulty experienced in applying it clinically. So many dentists abandon the technique in spite of the many of benefits bestowed upon the clinician who perseveres with the difficulties of its use. It should be acknowledged that with the full application of the conventional rubber dam technique, the greatest chances for achieving clinical excellence are attainable, and that in any clinical circumstance its use should be considered first as the application of choice if at all possible. The general field isolation rubber dam, then, is not meant to replace the conventional use of the rubber dam, but to work side-by-side with it as an extension of the use of it clinically. The measurement of its contributory value in elevating the attainment of clinical excellence, should be by comparison to practicing in the complete absence of the rubber dam, rather than to comparison with the full technique. A clinician and researcher known widely for innovations of rubber dam technique and an advocate for the widespread use of the rubber dam, has stated the problem concisely: “The indirect restorations are delivered with compromised access in the absence of the rubber dam isolation. There is good reason for this, because traditional rubber dam application is cumbersome and impractical for application during placement of multiple veneers, with their priority of gingival margin access.” Dr. William H. Liebenberg, Quintessence International, Vol. 26: No 7/1995, p. 493. He goes on to say; “General field isolation permits full interproximal access and as such is the ideal isolation method for those clinicians wishing to forgo the time-consuming impracticalities of traditional dam application.”. . . “Croll reintroduced it as a technique to ‘those dentists who would otherwise reject the dam in toto”. William H. Liebenberg, Quintessence International Vol. 24: No 1/1993, p.8.

### SUMMARY OF THE INVENTION

The invention consists of a series of modified rubber dam membranes which, alone and in association with other devices, allow unique alternative applications of the rubber dam to enable a dentist to isolate various portions of the alveolar arch (the term for the combined anatomical structures of both the teeth and their surrounding soft tissues or gums, including the bony support for same) at a single time. While the conventional rubber dam technique and usage relies on the perforation of individual holes in the rubber dam membrane and the individual isolation of each tooth exposed through a separate perforation, this series of devices generally isolate groups of teeth at a time, a technique called general field isolation in the prior art. While there have been attempts to isolate more than one tooth at a time by cutting a slit in a conventional rubber dam membrane with a scissors, a very limited and flawed technique called the slit-dam technique, to this date there have no systematic designs of alternative rubber dam membranes which address all of the problems of general field isolation in dentistry. This series of rubber dam innovations not only address the flaws and shortcomings of the conventional rubber dam technique, but outline a new, comprehensive and systematic approach to operative site isolation in the dental art.

The series of rubber dam membrane devices consist generally of a flat, elastomeric membrane, with an integral insert or appliance constructed within or applied to the membrane in order to modify the membrane in t least the area which forms the perimeter of a proposed operative dental site. The four general classifications of operative inserts are: elastic, malleable or capable of undergoing plastic deformation, resilient at least to an elastic limit, and rigid or substantially rigid. The elastic field isolation membranes may be constructed with or without integral barrier adhesives applied. Field isolation membranes with an integral operative insert classified as a malleable-type of insert may be easily configured by the clinician with finger pressure alone to adapt to the anatomical contours of an operative site, and also may have integrally applied adhesives as a part of their construction, or may have mechanisms for the attachment and integration of manually applied barrier materials to be applied. General field isolation membranes with resilient operative inserts may also be permanently deformed by the practitioner, either with finger pressure or with the use of dental or orthodontic bending pliers, but principally are designed to act in a resilient manner in order to be retained in position by reciprocal inter-arch forces applied by the patient's muscles of mastication. The resilient field isolation rubber dams may either have integrally applied barrier adhesives, or may have mechanisms for the manual application of barrier adhesives. The rigid classification of field isolation rubber dams have some exceptions to the rules of technique to the other general classifications of rubber dams, which will be addressed individually within the description of the text of this patent disclosure.

In general, all the variations of general field isolation rubber dam membranes may either have mechanisms for the manual application of various viscosities of liquid, paste, gel, or putty barrier substances to seal the tissue-dam interface, or may alternatively be constructed to have integrally applied pressure sensitive or chemically activated or photo-polymerized barrier adhesives to seal this interface. The approach to the design of general field isolation rubber dams for dentistry is not confined by overly rigid definitions of proposed clinical applicability, but by a flexible approach to interact with the needs and preferences of the dental practitioner to determine which modality of operative site isolation best suits his or her own requirements. Hence, while there are designs for the complete field isolation of groups of teeth simultaneously, designs are also described for the inclusion of a field isolation membrane which constitutes a hybrid approach to isolation with both the punching of individual perforations to isolate individual teeth and the option of using the slit-dam technique to isolate only a portion of the teeth for field isolation.

In addition, a field isolation rubber dam with either a solid planar sheet of malleable material interposed between polymeric external surfaces, or a mesh-type of malleable material enclosed as an operative insert, represents a departure from a purely elastic membrane, and allows the rubber dam to be fully contourable three dimensionally in its action, much like the action of a foil. Various flat-form configurations of field isolation rubber dams anticipate the isolation of various sizes and configurations of proposed operative sites; from openings as small as 2-3 teeth, to segments, to quadrants, ¾ arch, and entire alveolar arch designs. The methodology of general field isolation for various general types of field isolation rubber dams is described, as well as the application of the rubber dams to various different clinical specialty areas and also the isolation needs of exceptional clinical circumstances in which isolation needs are uniquely challenging.

Rubber dams have suffered from the fact that tensile forces induced in the rubber dam membrane during application and use are freely transmitted to the operative site, with the result that the rubber dam material may be pulled away from its desired location, particularly when being used for field isolation. The inserts of the present invention have the effect of preventing the transmission of these tensile forces to the interior of the perimeter of the insert. Accordingly, much smaller forces are induced on the rubber dam material in the are adjacent to the operative site so that the rubber dam material will either stay in its desired location or may be assisted by the use of adhesives or barrier materials of a much lower strength.

General field isolation rubber dams will be applicable to and meet the needs of both general dentists and dental specialists alike, with applications in operative dentistry, fixed prosthodontics, pedodontics, endodontics, orthodontics, implantology, periodontics, and oral surgery, and emergency dentistry. Finally, the techniques of general field isolation outlined in this disclosure will also have applicability to other areas of medicine, as well as veterinary dentistry.

The disclosure also describes ancillary field isolation devices which may either function as stand-alone devices for use to directly overcome the inherent shortcomings of conventional rubber dams prepared for the slit-dam technique of general field isolation, or they may be used as supporting apparatus for the improvement or refinement of the use of the specially designed general field isolation rubber dams for dentistry of the present invention. The field isolation ancillary devices are generally designed to be made of either stainless steel or other metal, or may alternatively be made of plastics or composites. These devices generally fall into an outline of two different types of apparatus, rubber dam frames and rubber dam clamps. The rubber dam frames described fall into two general classifications: first, are rubber dam frames which are manually applied to a rubber dam by the operator. The second type of field isolation rubber dam frames are integrally applied to the rubber dam in the process of its construction. Generally, the types of integral frameworks may either be made of a malleable, resilient, or rigid material, made generally of metal or plastic or composite. They are an important part of the proper application of rubber dam technology to dentistry.

The second type of general field isolation apparatus are rubber dam clamps designed for field isolation. These fall into two general classifications, clamps designed for enhancement of the slit-dam method of field isolation, and clamps designed as supporting apparatus to the specially designed general field isolation rubber dams. Although the designs are generally interchangeable, not all variations work well as stand-alone devices, just as others do not work well as supporting apparatus.

### BRIEF DESCRIPTION OF THE DRAWINGS

FIG. 1 is a plan view of a general field isolation rubber dam of the present invention.

FIG. 2 is a cross-sectional view of FIG. 1 taken along the line 2-2.

FIG. 3 is a cross-sectional of a general field isolation rubber dam wherein an opening has been formed in the membrane.

FIG. 4a is a plan view of a general field isolation rubber dam wherein a fabric or mesh material is provided for use with a barrier material, and FIG. 4b is a cross-sectional view of FIG. 41 taken along line 4b-4b.

FIG. 5 is a cross-sectional view of a general field isolation rubber dam wherein a fabric or mesh material has been applied to the membrane.

FIG. 6 is a view corresponding to FIG. 3, wherein an adhesive and a peel strip have been added to facilitate bonding of the dam inside a patient's mouth.

FIG. 7 is a cross-sectional view of a general field isolation rubber dam wherein the operative insert extends interiorly of the inner periphery of the membrane.

FIG. 8 is a cross-sectional view of an alternative embodiment wherein the operative insert is formed by a thickened section of the membrane material.

FIG. 9 is a view corresponding to FIG. 8, wherein an adhesive and a peel strip have been added to facilitate bonding of the dam inside a patient's mouth.

FIG. 10 is a cross-sectional view of an alternative embodiment wherein the operative insert is applied to the membrane rather than embedded in it.

FIG. 11 is a view corresponding to FIG. 10 with a fabric or mesh material applied to the membrane interiorly of the operative insert.

FIG. 12 is a view corresponding to FIG. 10, wherein an adhesive and a peel strip have been added to facilitate bonding of the dam inside a patient's mouth.

FIG. 13a is a cross-sectional view of an alternative embodiment wherein a malleable sheet is embedded in the membrane, and FIG. 13b is a cross-sectional view of an alternative embodiment wherein a malleable mesh is embedded in the membrane.

FIG. 14 is a cross-sectional view of a wafer-shaped operative element that can be attached to a rubber dam membrane to create a field-assembled embodiment of the present invention.

FIG. 15 is a cross-sectional view of an alternative embodiment of the wafer-shaped operative element.

FIG. 16 is a cross-sectional view of another alternative embodiment of the wafer-shaped operative element.

FIG. 17 is a cross-sectional view of an alternative embodiment of the wafer-shaped operative element.

FIGS. 18-21 are cross-sectional views of embodiments of the invention wherein discontinuous operative inserts are employed.

FIGS. 22a-22h are isometric views of a number of the diverse shapes that a clinician may give to a malleable operative insert in preparing the general field isolation dam for insertion into the mouth of a patient.

FIGS. 23a-23i are a sequence of views showing manipulation of a dam for use in isolating a posterior segment of a patients teeth.

FIGS. 24a-24j are a sequence of views showing manipulation of a dam for use in isolating an anterior segment of a patients teeth.

FIG. 25 is a plan view of a general field isolation dam with holes punched in it for use in a technique that is a hybrid of the present invention and conventional rubber dam techniques.

FIGS. 26a and 26b are a side and plan view, respectively, of a rubber dam clamp used in conjunction with a general field isolation dam of the present invention.

FIG. 27a is a plan view of a dam of the present invention for isolating a whole arch, and FIG. 27b is a cross-sectional view of FIG. 27a taken along line 27b-27b.

FIGS. 28a-28e are a sequence of views showing manipulation of a dam having a resilient and deformable operative insert which relies on mandibular pressure rather than a rubber dam clamp to secure the dam in place.

FIGS. 29a-29d are views of a general field isolation dam of the present invention having a resilient operative insert for use in isolation both arched simultaneously.

FIGS. 30a and 30b are plan views of alternative embodiments wherein discontinuous operative elements are used.

FIG. 31 is a perspective view of an embodiment of the invention wherein a malleable sheet is engaged with the elastomeric material to form a foil dam fully contourable in all three dimensions.

FIG. 32 is a perspective view of a rubber dam of the present invention wherein a photoactivated adhesive is being cured by a dental light unit.

### DETAILED DESCRIPTION OF PREFERRED EMBODIMENTS

The general field isolation dams of the present invention may take a variety of forms or embodiments.

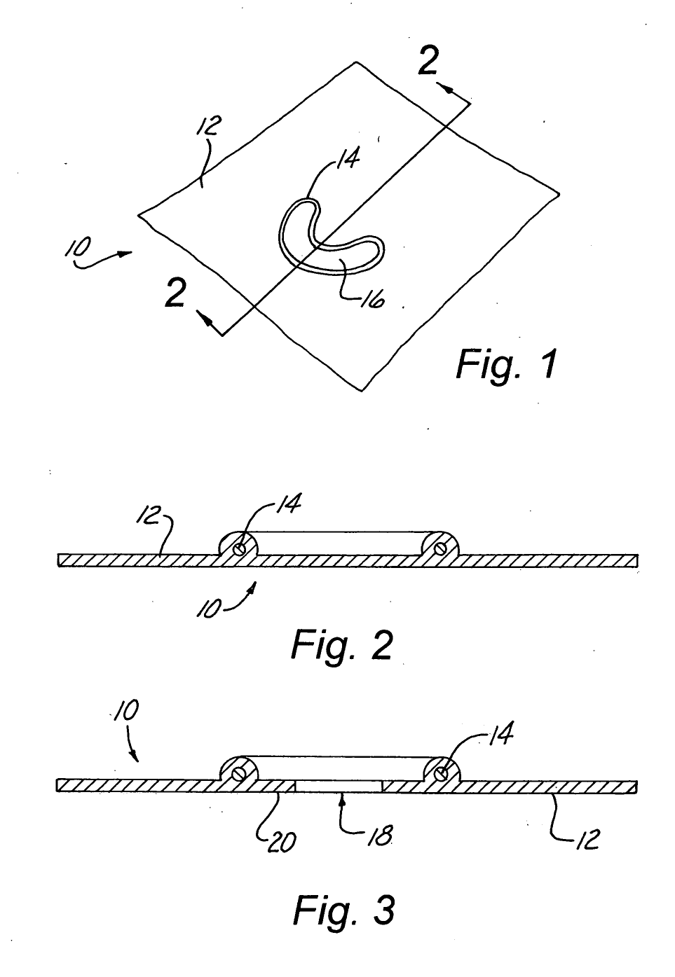

One embodiment of a general field isolation dam of the present invention is illustrated generally in FIG. 1 at 10. The dam 10 is formed of a sheet or membrane 12 of an elastomeric material, such as latex, neoprene, silicone, polyurethane or other polymeric material. A closed loop insert 14 is embedded within the membrane 12 and defines an interior area 16 of the membrane 12. While the closed loop insert 14 is illustrated to be a pair of spaced apart arcs with closed ends, the insert 14 can take a wide variety of shapes depending on the material used for the insert 14 and the particular field of application of the rubber dam 10. A cross-section of the dam 10, illustrated in FIG. 2, shows the insert 14 wholly embedded in the membrane 12.

The dam 10 may either be manufactured as illustrated in FIGS. 1 and 2, wherein the interior area 16 of the membrane is un-perforated, or it may be manufactured with a pre-formed opening 18, as illustrated in FIG. 3. In either case, a clinician using the dam 10 may use a punch, scissors, or other tool to create an opening of any desired shape. Upon formation of an opening 18, it will be appreciated that a flange 20 of the membrane 12 will extend inwardly around the interior periphery of the insert 14. This embodiment of the dam 10 may be used alone, that is, without any manually applied barrier material, or it may be used in conjunction with manually applied barrier materials or with an adhesive to assist in proper positioning and retention of the rubber dam 10, as will be described in more detail below.

The insert 14 may be made of a wide variety of materials, depending on the physical characteristics that are desired for the insert 14. For example, the insert 14 may be made of an elastic material that can be stretched to a desired shape and provide an elastic retaining force to assist in keeping the dam is the desired position as a result of the elastic material attempting to return to its original, un-stretched shape. Elastic inserts 14 may be made by the use of a selected elastic material for embedding in the membrane 12 during formation (such as injection molding), or may be simply an area of increased thickness of the elastomeric material used in forming the membrane 12. The insert 14 may be made of a malleable material that is easily deformable by hand to any desired shape and which will retain the shape to which it is deformed. A particularly suitable material is un-tempered or substantially un-tempered wire that requires a force of between about 1 pound and about 6 pounds to be deformed, and preferably between about 2 and about 3 pounds. The insert 14 may be made of a material that is resilient over most of its operative parameters but which also may be deformed if bent past its deformed limit. In such an embodiment, the insert 14 would exert a spring force to attempt to return to its original shape except in areas where the clinician had intentionally manipulated the insert 14 past its deformed limits to shape it for a particular patient or procedure. Finally, the insert 14 may be made of a rigid material which resists bending forces encountered during there use.

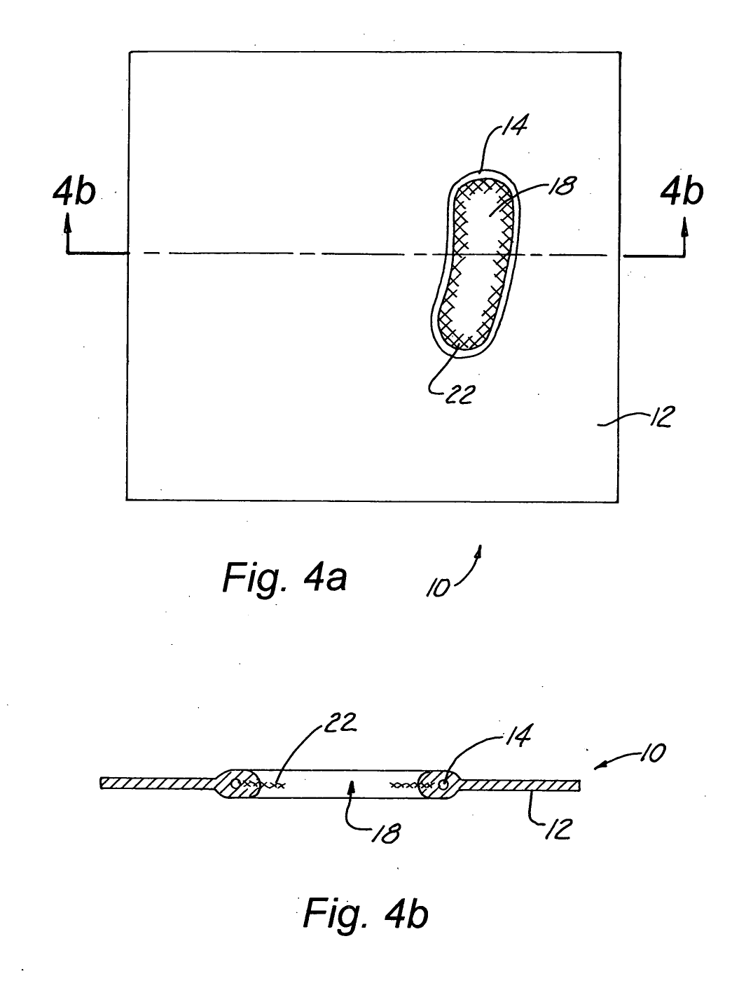

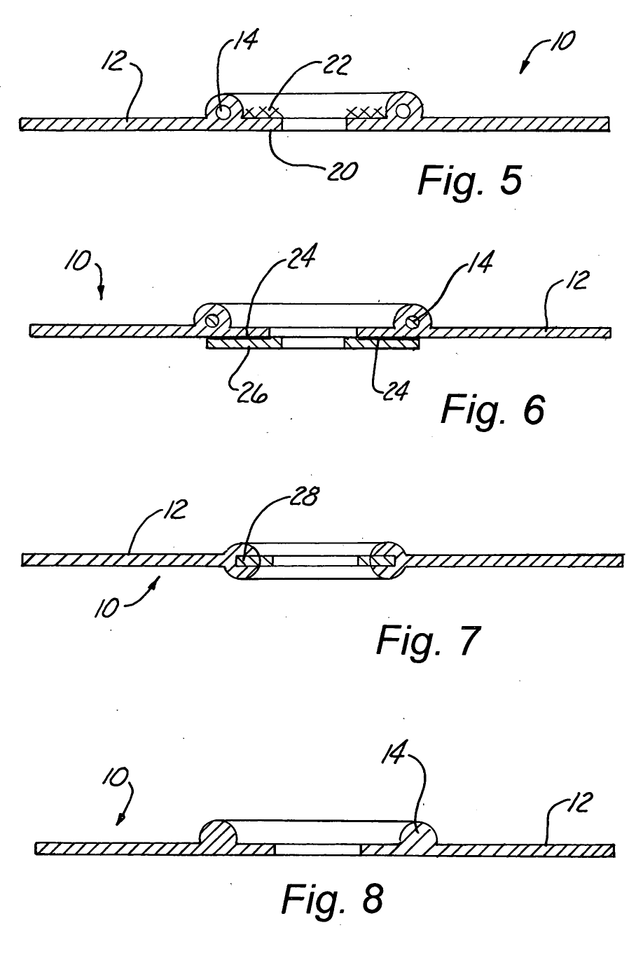

In an alternative embodiment, the area to the interior of the closed loop insert 14 may be comprised of a fabric or mesh material 22 (FIG. 4), for application of manually applied, non-adhesive barrier materials. The fabric or mesh material 22 provides a large number of interstices to provide good bonding with the barrier materials. Alternatively, the fabric or mesh material 22 may be applier over the membrane 12 in the interior area 16 of the insert 14, as illustrated in FIG. 5. This would allow use of this embodiment of the dam 10 either with a barrier material that is bonded to the fabric or mesh material 12 or without it wherein the dam functions similarly to the one illustrated in FIGS. 1-3.

In a further alternative embodiment, the dam 10 is provided with an adhesive 24 applied to the tissue surface side of the flange 20 (FIG. 6). The adhesive 24 may be exposed upon removal of a peel strip 26, as illustrated, or it may be an adhesive that is activated by applied chemicals or light (photoactivated adhesives). FIG. 32 shows a rubber dam 10 of the present invention being adhered inside the mouth of a patient wherein a photoactive adhesive is being cured by a dental light unit 96.

Alternatively, the dam 10 may be manufacture with a using an operative insert 28 that extends beyond the membrane 12 interiorly of the inner periphery of the closed loop form of the insert (FIG. 7). The inwardly extended portions of the insert 28 may be of any desired shape. One application of the inserts 28 would be to provide a site which could be releasable secured to the gingiva by sutures as a method of positioning of the rubber dam 10 at an operative site.

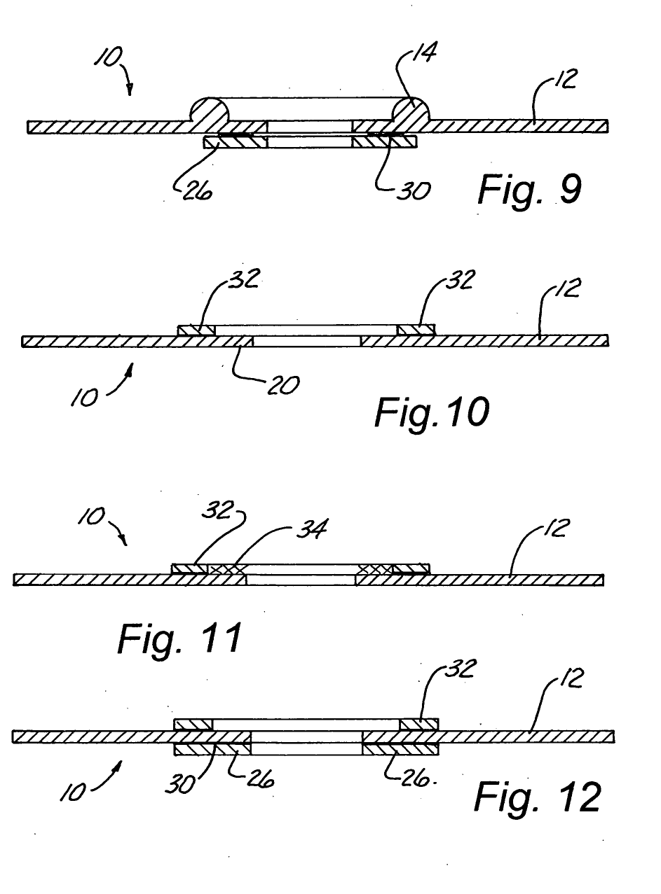

An alternative embodiment wherein the insert 14 is an elastic member is illustrated in FIG. 8. Although the illustrated insert 14 is manufactured by providing a thickened section of the same material forming the membrane 12, it may also be formed of a different elastic material than that comprising the membrane 12. In a further modification of the embodiment of FIG. 8, the dam 10 is provided with an adhesive 30 applied to the tissue surface side of the flange 20 (FIG. 9). The adhesive 30 may be exposed upon removal of a peel strip 26, as illustrated, or it may be an adhesive that is activated by applied chemicals or light (photoactivated adhesives).

An additional class of embodiments may be manufactured wherein the operative insert is applied to the surface of the membrane 12 as opposed to be integrally formed embedded in the membrane 12 as in the previously described embodiments. In FIG. 10, the dam 10 is shown in cross-section wherein an operative insert 32 has been applied to the membrane 12 and a portion of the interior area of the membrane 12 removed to form a flange 20. The operative insert 32 may be comprised of any of the materials and have the corresponding properties as described with respect to the embodiments of FIGS. 1-8. The embodiment of FIG. 10 may be further modified by the addition of a fabric or mesh material 34 (FIG. 11) or an adhesive 30 with or without a peel strip 26 (FIG. 12).

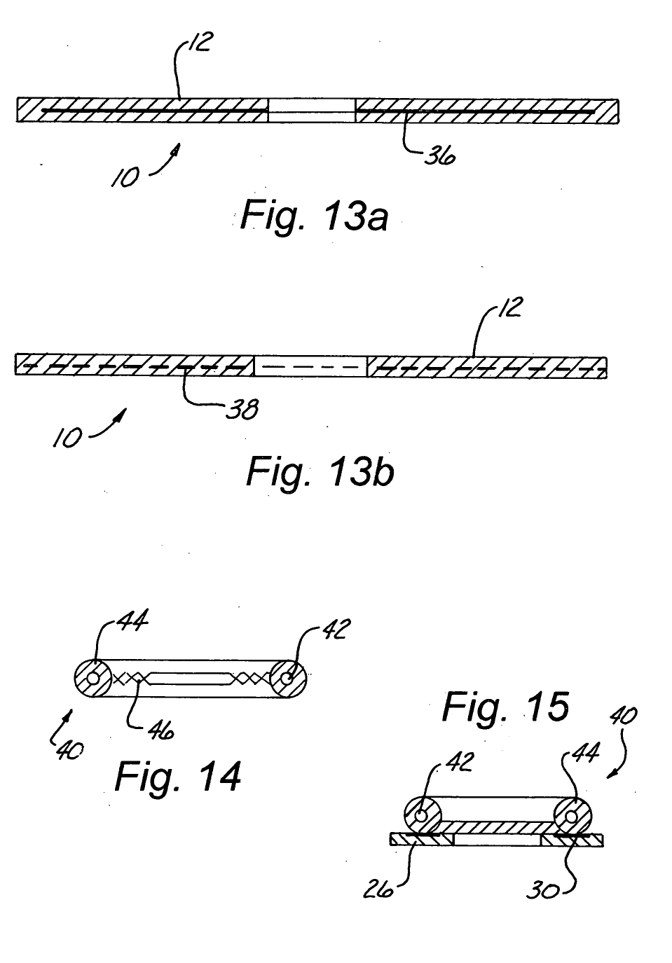

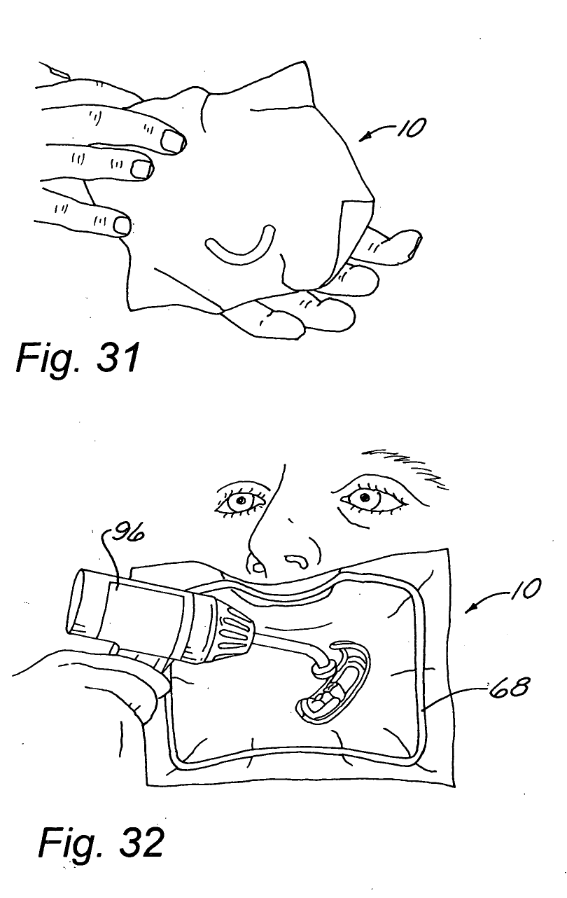

Another class of embodiments of the invention may be formed wherein a sheet of a malleable material 36 (FIGS. 13a and 13b), such as a metal foil, is embedded throughout the membrane 12. The sheet of malleable material 36 would allow three-dimensional deformation of the entire dam 10 similarly to a metal foil, as illustrated in FIG. 31. Alternatively, the malleable material could be a mesh, as illustrated in FIG. 13b at 38 and either the sheet 36 or the mesh 38 could be attached to a surface of the membrane 12 as opposed to being embedded in it. Either of these embodiments could be manufactured with or without a central opening, with or without an adhesive, with or without a fabric or mesh material portion, and the like as described with respect to previous embodiments.

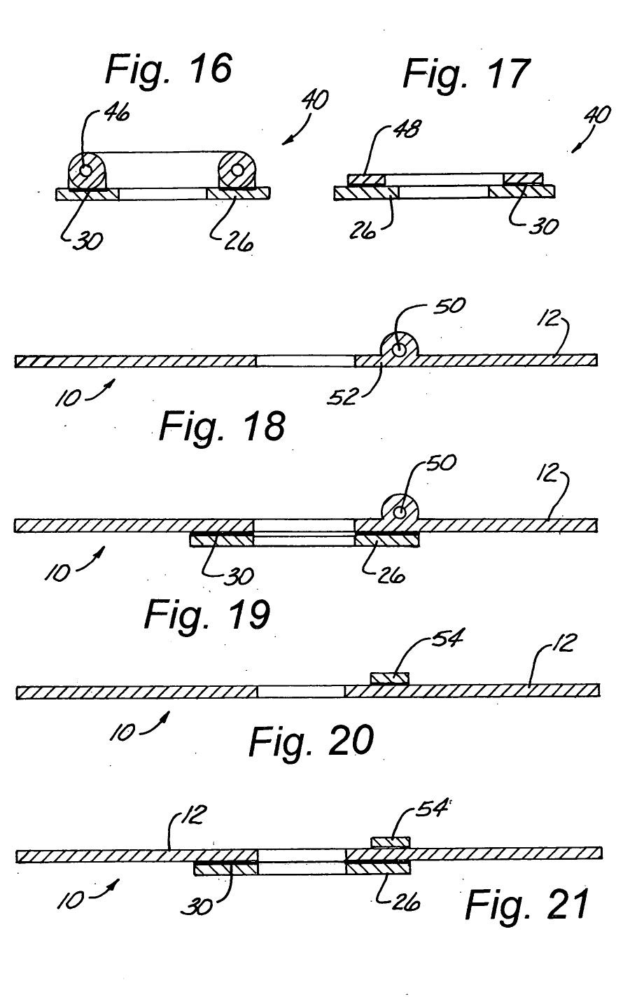

Yet another class of embodiments of the invention are illustrated in FIGS. 14-17. A wafer-like operative element 40 for field assembly of a general field isolation rubber dam of the present invention is comprised of an operative insert 42 embedded within a polymeric coating 44. The operative element 40 may be secured to a conventional rubber dam sheet by adhesives or the like to form a general field isolation dam of the present invention which is thereafter used as described throughout this disclosure. Alternatively, the operative element can be placed around the operative site in the patient's mouth and then a conventional rubber dam prepared with a suitable central opening and then stretched over the periphery of the element 40 and held in place by constriction of the membrane around the element 40. An element 40 having a fabric or mesh material flange 46, particularly suited for use with a barrier material, is illustrated in FIG. 14. An alternative embodiment wherein an adhesive 30 has been applied to the operative element 40, with or without a peel strip 26, is illustrated in FIG. 15. This embodiment is illustrated with the option of a solid interior membrane which is prepared by the clinician for the hybrid approach of isolating some teeth through holes and other teeth that are scheduled for field isolation by preparing a slit. The conventional rubber dam is then prepared to be stretched over the operative element 40. The element 40 and the rubber dam are attached to each other by a pressure sensitive or other adhesive to form a field assembled general field isolation rubber dam of the present invention. The embodiment of the operative element 40 of FIG. 16 has a malleable or resilient wire or stamping or other core 46 without any polymeric membrane or flange. It is placed on a conventional rubber dam membrane and attaches by adhesive or bonding. The element 40 has a pressure sensitive adhesive 30 covered by a peel strip 26. Upon attachment to a polymeric membrane, the clinician has a choice of cutting a slit in the inner area of the membrane or by punching holes for the isolation of individual teeth and then also punching or cutting a slit for select teeth to be field isolated. An operative element 40 comprises a malleable metal stamping or wire or memory-retaining plastic insert 48 (FIG. 17), without a polymeric outer covering, and including an integral adhesive 30 applied to one surface for attachment to a polymeric membrane. A peel strip 26 is shown, but may not be necessary, depending on the type of adhesive applied. Upon attachment of the operative element 40 to a membrane, it is used as described with respect to the embodiment illustrated in FIG. 16.

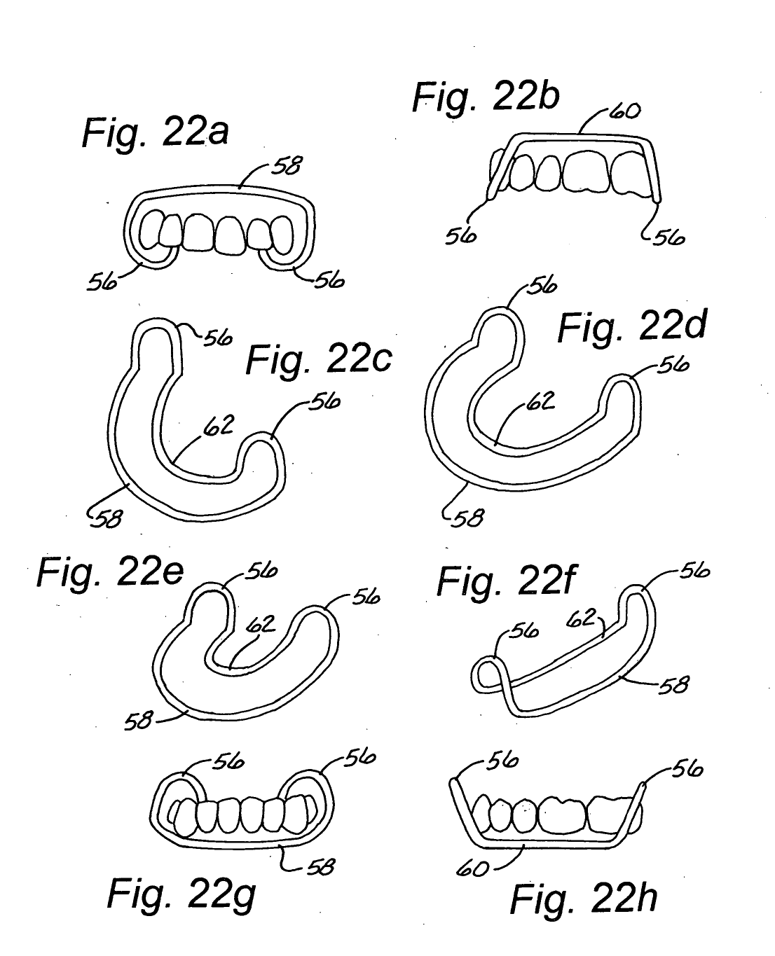

Still another class of embodiments of the present invention are illustrated in FIGS. 18-21. These embodiments employ an operative insert 50 that is discontinuous, that is, it does not form a closed loop as in the previously described embodiments. In FIG. 18, the operative insert 50 is embedded within the polymeric membrane 12 and a flange 52 extends inwardly of the operative insert 50. An adhesive 30, with or without a peel strip 26, may be employed with the discontinuous embodiments (FIG. 19). A general field isolation rubber dam with a single or double non-continuous malleable or resilient wire, metal stamping, or memory-retaining plastic or composite insert 54 attached to a surface of the membrane 12 by adhesive, bonding, or other manufacturing process is illustrated in FIG. 20, and a modified version using an adhesive 30, with or without a peel strip 26 is illustrated in FIG. 21. The discontinuous embodiments will not isolate the tensile forces present in the membrane 12 that are exerted from a direction opposite of the operative site from the operative insert 50. These embodiments may be viewed, accordingly, as alternatives that may function as desired in certain circumstances where the tensile forces in the membrane 12 on the side opposite the operative insert 50 are not so large as to interfere with the operation of the general field isolation rubber dam or the use of adhesives or barrier materials may be sufficient to retain the unprotected membrane material in place.

All dams 10 are manufactured in an FDA approved and registered medical device manufacturing facility and meet the standards of latex and neoprene fabrication intended for medical use. In addition, the polymers which the dams are fabricated from conform to the following material safety specifications: The latex rubber dams are pure latex and have identical properties for allergenicity as any standard medically approved latex product, including commercially distributed latex rubber dams in use in clinics and dental offices throughout the U.S. and abroad; and the neoprene rubber dams are significantly safer than latex and pose virtually no allergenicity that is known to be reported in medical literature.

The general field isolation rubber dams of the present invention that have a malleable insert are manipulated by the clinician to conform closely to the site to be isolated. Specifically, the clinician will form the malleable insert to a create transverse arch on either end and a lingual bow to the interior and a labial or buccal bow (both of which may be defined as facial bows) to the exterior. Eight exemplary shapes are illustrated in FIGS. 22a-h, wherein references numerals 56, 58, 60, and 62 are used to identify the transverse arches, the labial bow, the buccal bow, and the lingual bow, respectively. Note that the transverse arches 56 cross over the arch while the labial bow 58 or buccal bow 60 follows the outer contour of the arch and the lingual bow 62 follows the inner lingual contours of the arch. All four elements must be present in an operative perimeter in order for the work site to be surrounded by the operative insert.

Posterior Quadrant Applications

The use of the rubber dam in isolating a posterior segment or quadrant of teeth for treatment is the most challenging application of the rubber dam. The dam must be stretched to its maximal extension beyond the plane of the rubber dam frame to reach a single most posterior molar which has been clamped with a rubber dam clamp. High internal tensile forces are generated due to this extensive stretching, so the reciprocal forces of retention need to be at their highest value at the for this application. The tensile forces generated by flexure of the rubber dam material are additive and converge at this point of maximum flexure. It was for good reason that the first refinement of rubber dam technique after the invention of the rubber dam was the rubber dam clamp. Properly applied, the rubber dam clamp provides a secure anchor for retaining the dam in the mouth. Whether the application of the dam is the conventional technique of punching holes in the dam and then pulling the rubber sequentially over each individual tooth, or the alternative application of the general field isolation dam where the whole quadrant is isolated as a unit, the resistance of maximal forces generated by the tension between the operative site and the rubber dam framework is best accomplished by the conventional rubber dam clamp.

Tensile forces are generated by the stretching of the rubber dam between a posterior quadrant operative site with a single rubber dam clamp resisting the summation of tensile forces converging toward the single point of maximal flexure. Since this application extends further into the oral cavity than isolating an anterior segment of teeth, the tensile forces generated are of a higher magnitude than in an anterior application.

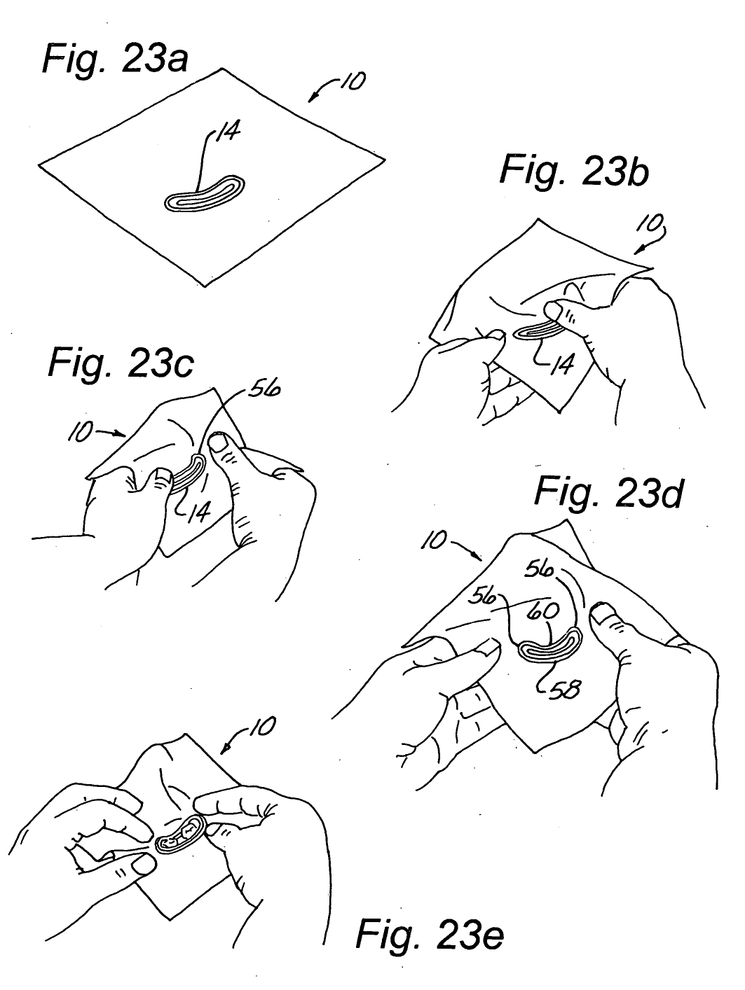

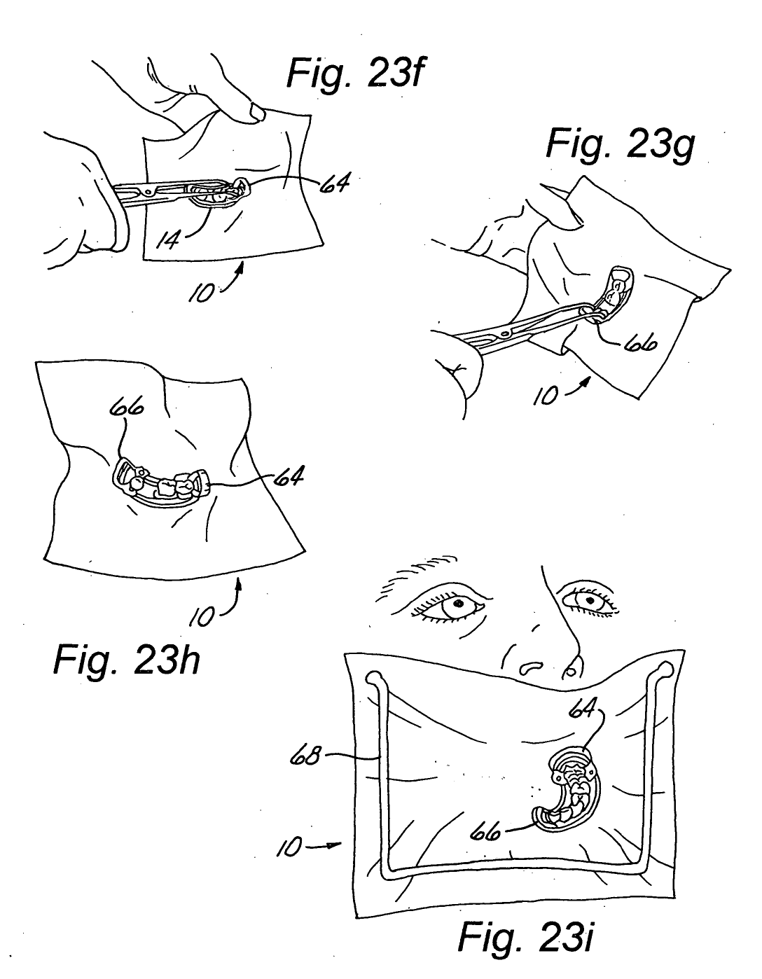

FIGS. 23a-i show the sequence of steps in using the general field isolation dams of the present invention to isolate a posterior segment. A dam 10 has a malleable wire insert 14 in the general shape of the posterior segment to be isolated (FIG. 23a). The clinician forms one of the transverse arches 56 by deforming the malleable wire insert 14 (FIG. 23b) and then the other transverse arch 56 by deforming the other end of the malleable wire insert 14 (FIG. 23c), resulting in a formed dam 10 having a pair of transverse arches 56, a lingual bow 62 and a labial bow 58 (FIG. 23d). The dam 10 is then placed around the teeth of the patient in the area where the dental procedure is to be performed (FIG. 23e). A rubber dam clamp 64 is applied to a posterior tooth (FIG. 23f) and a second rubber dam clamp 66 is applied to an anterior tooth (FIG. 23g), resulting in the configuration illustrated in FIG. 23h. Finally, a rubber dam frame 68 is applied in the conventional manner (FIG. 23i).

Anterior Segment Isolation

The use of the rubber dam in isolating the anterior segment of teeth for treatment is somewhat less challenging than isolating the posterior quadrants for treatment for a number of reasons. First, the rubber dam does not need to be stretched from the plane of the rubber dam framework to the extent that the posterior application requires. This means that the internal tensile forces that are generated are less than for the other applications. Second, two rubber dam clamps are applied to retain the most posterior portion of the dam, thus dividing the tensile forces between the two for a more manageable stability of each individual clamp. Third, the application of the clamps and the dam are symmetrical, and therefore the forces are distributed in an equal manner with regard to the symmetry of the anatomy of the patients face and the location of the operative site within the rubber dam framework. This symmetry of this type of application is the same, whether the maxillary or mandibular anterior segment is to be isolated.

Tensile forces are generated by the stretching of the rubber dam from a symmetrical anterior operative site with bilaterally anchored rubber dam clamps. There is a more balanced distribution of forces from side to side due to the two lesser points of maximal flexure at the rubber dam clamps. In addition, the summation of all tensile forces are of a lower magnitude because the application is in the front of the mouth and does not need to be flexed as far from the plane of the rubber dam frame.

While rubber dam clamps resist maximal tensile forces generated in either the conventional rubber dam technique or the alternative general field isolation rubber dam technique, there are significant differences in the two applications with regard to retention of the two types of rubber dams. In the conventional technique, the rubber is flossed between the teeth and the teeth are drawn through the holes punched in the dam. When the dam is in place and the rubber material contracts around the necks of the teeth, the teeth being isolated become anchors for retention of the dam to the operative site. This additional retention is a significant force in the overall retention of the dam in the conventional rubber dam application.

In the general field isolation rubber dam technique, the rubber dam clamps also serve to resist maximal tensile forces, but the teeth being isolated do not contribute to the overall retention of the rubber dam in the same manner as in the conventional technique. Rubber dam clamps are placed at each end of the operative perimeter to retain and stabilize the wire insert of the operative perimeter. The wire insert, stabilized in position, then serves to resist the tensile forces of the stretched rubber dam from all directions and transfers the stresses to the retaining clamps and anchor teeth chosen to retain the dam. The resistance of tensile forces by the insert allows the flange of the dam to be attached to dental tissues with a barrier material, either applied by the clinician or integrally applied in the construction of the dam. Since the tensile forces are absorbed by the insert, a stable attachment by the barrier material linking the flange-tissue interface may be accomplished.

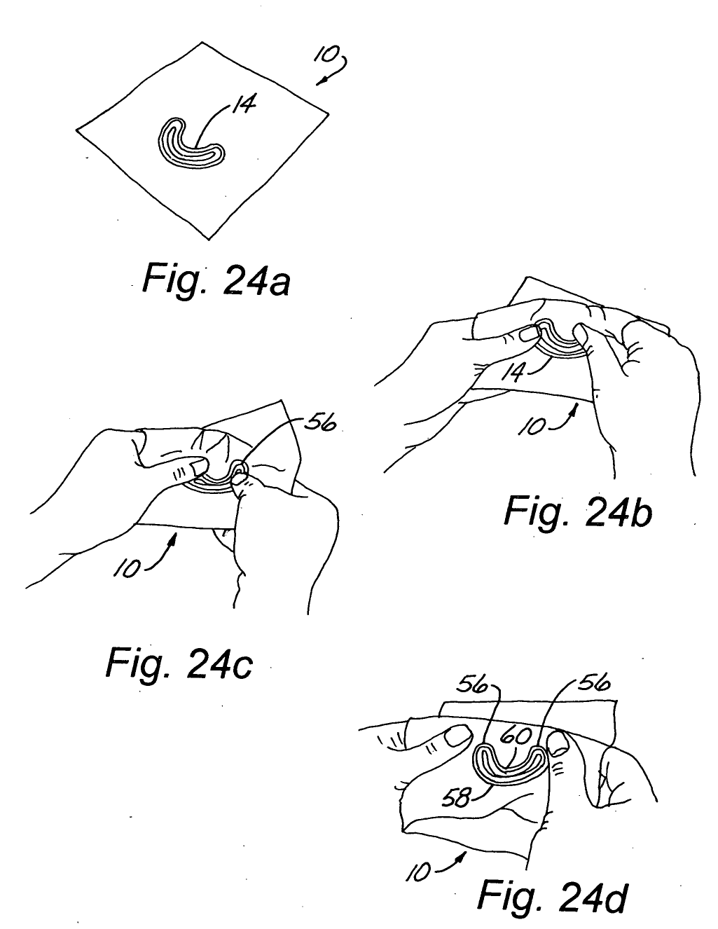

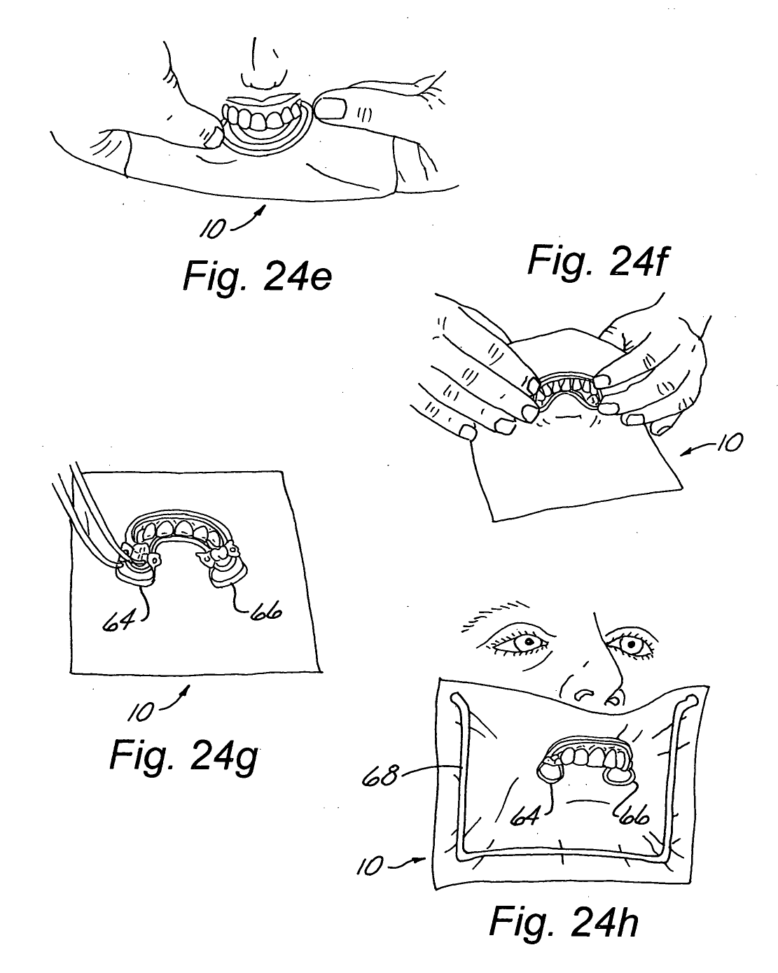

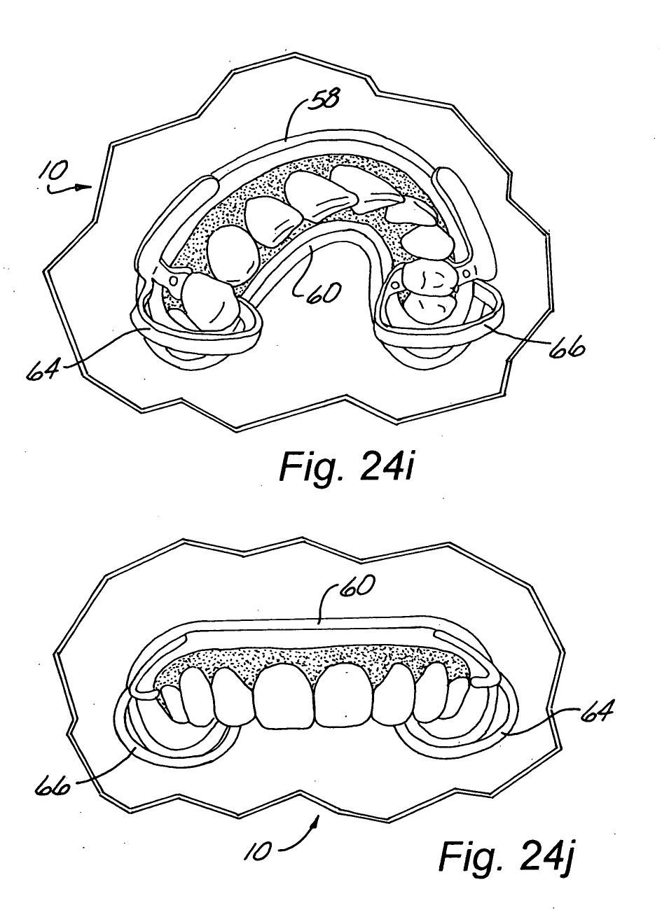

FIGS. 24a-h show the sequence of steps in using the general field isolation dams of the present invention to isolate an anterior segment. A dam 10 has a malleable wire insert 14 in the general shape of the anterior segment to be isolated (FIG. 24a). The clinician forms one of the transverse arches 56 by deforming the malleable wire insert 14 (FIG. 24b) and then the other transverse arch 56 by deforming the other end of the malleable wire insert 14 (FIG. 24c), resulting in a formed dam 10 having a pair of transverse arches 56, a lingual bow 62 and a labial bow 58 (FIG. 24d). The dam 10 is then placed around the teeth of the patient in the area where the dental procedure is to be performed (FIGS. 24e and f). A rubber dam clamp 64 is applied to a tooth on one side of the segment and a second rubber dam clamp 66 is applied to a tooth on the other side of the segment (FIG. 24g). Finally, a rubber dam frame 68 is applied in the conventional manner (FIG. 24h). FIG. 24i is an enlarged perspective view and FIG. 24j is an enlarged rear view of the rubber dam 10 in place.

Applications of the Embodiments

A. A General Field Isolation Rubber Dam with Fabric or Synthetic Mesh Material for Application of Manually Applied Non-Adhesive Barrier Materials

Illustrated in FIG. 4, generally at 10, is a general field isolation rubber dam with fabric or synthetic mesh material for application of manually applied non-adhesive barrier materials, including an elastic membrane 12 showing the square outer perimeter of the membrane 12, and an oblong or elliptical open area 18 in a central area of the membrane 12. The outer perimeter of the opening 18 is bordered by a fabric or synthetic mesh material 22 approximately 2.5 to 3.0 millimeters in thickness, following the opening 18 all the way around the periphery with an unseen amount of the material 22 securely embedded in the rubber material of the membrane 12. Adjacent to the mesh material 22 in an outer direction from the internal opening is a raised thickened section of elastic material which is 2.0 to 3.0 millimeters in width and extends all the way around the periphery of the opening 18. Located within the thickened section of the membrane 12 is a malleable, dead-soft wire loop 22 embedded in the membrane 12 which allows the operator maximum flexibility to create a three-dimensional operative work site in order to isolate multiple teeth and their associated soft tissues.

This embodiment of the general field isolation rubber dam 10 allows the clinician to manually apply a liquid, putty, gel, or paste elastomeric material as a barrier material to create a moisture proof seal around the periphery of the operative perimeter of the general field isolation rubber dam 10. No adhesive need be applied to bond the polymeric barrier material to the dam 10, nor is there any need for a barrier material composition with an integrally applied adhesive within it to attach it to the dam 10. The barrier material used needs only to have properties of adequate wetting and flow of the barrier material into the fabric mesh 22, in order to lock the fully polymerized material into the microscopic retentive fibers of the mesh material 16. This design allows quite a number of different chemical compositions of polymeric materials to be used with this dam in creating a moisture proof seal at the interface between the dam and the tissues to be isolated. This dam is not to be used without an applied barrier material.

B. Fabric Mesh over a Membrane Backing

A general field isolation dam with a fabric or synthetic mesh over a membrane backing (FIG. 5) gives the clinician the option of using a non-adhesive polymeric barrier material or foregoing the use of the perfection of the tissue-dam seal. If intricate implant components are to be used, the moisture-proof seal should be perfected with the final barrier material. If, however, a less intricate procedure is planned, like charting with a perio probe, the dam may be used without a barrier material. Also, if a barrier material with a low viscosity is to be used, the membrane backing is an added guarantee that the material will not flow through the mesh material and drip into the oral cavity before polymerization.

C. Latex or Polymer Membrane Only Flange

A general field isolation rubber dam with a latex-only inner border, i.e., without the mesh material 22, may be used alone without any barrier material, in the application of an adhesive with a brush, followed by a barrier material which adheres to the membrane by the applied adhesive, and in the application of any barrier material with an integrally applied adhesive composition within the barrier material itself. Note that the use of this embodiment does not require the manual application of an adhesive prior to application of this type of barrier material.

D. Polymer Membrane Only, Without Any Central Opening

A general field isolation rubber dam with a polymeric membrane 12 only and without any central opening 14 cut within the operative perimeter is primarily used with a hybrid technique described where holes are punched within the membrane 12 as in the conventional technique, then a scissors are used to cut a slit in the dam 10 specifically where the practitioner wants to apply the slit-dam general field isolation technique. This combination hybrid technique gives the dental practitioner maximum flexibility to configure the application to his or her specifications

E. The General Field Isolation Rubber Dam With an Integrally Applied Mucosal Tissue Adhesive

Another embodiment is a general field isolation rubber dam with a latex inner border and a pre-applied mucosal tissue adhesive to bond the latex membrane directly to the hard and soft intra-oral dental tissues. Integrally applied tissue adhesives are described in detail under the section pressure sensitive adhesives or non-pressure sensitive adhesives.

F. General Field Isolation Rubber Dam With A Metal Stamping or Die-Cast Framework

With Surgical “T”s for Suturing the Extended Dam in Surgical Applications Another embodiment of the general field isolation rubber dam comprises the addition of surgical “T”s built into the operative insert 28 (FIG. 7) is a surgical dam that is detailed within the text of the section describing surgical applications

G. A General Field Isolation Rubber Dam Without a Wire Insert But With an Integrally Applied Enhanced Adhesive Which Acts as a Barrier Material and also Retains the Dam

This dam embodiment is described in detail in the section associated with integrally applied adhesives which act as barrier materials and also are enhanced to be retentive of the dam to the hard and soft tissues

H. The General Field Isolation Rubber Dam Without a Wire Insert and Without an Integrally Applied Adhesive

This dam is constructed for the clinician who may want to apply an enhanced retentive adhesive which will retain the dam and also act as a barrier material

I. General Field Isolation Rubber Dam Inserts for Field Assembly of a General Field Isolation Rubber Dam With Textile Mesh and Without an Integrally Applied Adhesive

The general field isolation rubber dam operative inserts 40 (FIGS. 14-17) without a membrane attached allow an inexpensive alternative for the clinician wanting a field isolation technique using conventional materials with the slit-dam technique of modifying a conventional rubber dam polymeric barrier materials are manually applied by the clinician to create a moisture-tight seal and to stabilize the insert before application of the membrane

J. General Field Isolation Rubber Dam Inserts for Field Assembly of a General Field Isolation Rubber Dam With Textile Mesh and With an Integrally Applied Adhesive

The general field isolation rubber dam operative elements 40 (FIGS. 14-17) for field assembly of a general field isolation rubber dam provide an inexpensive alternative for a clinician wanting to use conventional materials to assemble a general field isolation dam. The integrally applied adhesive allows a bonding of the interface of the operative element to the conventional rubber dam material which may be somewhat more moisture-proof that the insert without the integrally applied adhesive.

Areas of Particular Applicability of the General Field Isolation Rubber Dam

The general field isolation rubber dams of the present invention are expected to have particular applicability in the following fields of dental and medical practice.

Operative Dentistry

General field isolation dams will be of great benefit in many operative dentistry procedures that cannot be accessed with the conventional technique. The isolation of grossly carious teeth that no longer have intact clinical crowns due to their complete breakdown by the disease process will be able to be isolated with this technique. If the severely carious teeth are in the most posterior placement within an arch, a specialized design of the general field isolation dam will aid in the isolation of this specialized circumstance.

In addition, teeth with deep subgingival caries; either facial or lingual deep Class Vs and also deep interproximal Class IIs are excellent candidates for this application.

Porcelain laminate veneers, which require subgingival access for preparing the margins of the preparations below the gumline and for the packing of retraction cord in the gingival sulcus, and later to adhesively bond the veneers to the enamel or dentin, are perfectly served by this technique. In these procedures, the adhesive bonding is very technique-sensitive and the strength of the bonding of the porcelain veneer to tooth structure is greatly enhanced with the quality of dry field that rubber dam application provides. The indirect techniques of porcelain and composite and CAD CAM computer generated ceramic inlays, onlays, and crowns are also bonded applications with this sensitivity for dry field technique that only a rubber dam can satisfy.

Pedodontics

Children will adapt to an easier rubber dam technique with less flossing and difficulty in the application phase. Some procedures will readily be satisfied by the new technique. Young children with severe “milk bottle caries”, a condition where multiple teeth are grossly decayed to the extent that their clinical crowns are broken down to the level of the gumline will be excellent candidates for the application of the general field rubber dam. The placement of stainless steel crowns and plastic provisional crowns for the young child will be well served by the technique.

Endodontics

The conventional rubber dam technique is the application of choice in endodontic procedures, except in the exceptional circumstance where isolation is impossible with the conventional technique. Single or multiple grossly carious teeth without clinical crowns qualify as indications for general field isolation during endodontics. In addition, if the grossly carious teeth are distally located in the arch, a specialized design of a general field isolation dam may be of benefit in this type of isolation. An intact barrier material application creating a competent seal around the entire operative perimeter is universally required to prevent any endodontic files or components from being swallowed or aspirated. In addition, all files used for endodontic applications with the general field isolation dam should be ligated with dental floss to insure a second line of defense to the problem of aspiration.

Periodontics

Periodontal procedures have universally been accomplished without any rubber dam involvement and it is anticipated that the changes to clinical practice in this area will be resisted or remain largely unchanged with this new technique. One possible benefit to the periodontist, however, will be in the area of application of medicaments, which can be diluted by saliva and subsequently be less efficacious in their anticipated clinical effect. In addition, medicaments and chemical agents applied to the periodontium often trickle down the patient's throat without isolation, causing discomfort to the patient. The general field isolation dam, with an intact barrier seal would prevent the bitter taste of such agents and as such make the patient more comfortable during treatment.

The insertion of membranes in guided tissue regeneration would benefit from an improved isolation technique which elevates standards of asepsis during the insertion phase. In cases where a flap must be elevated for the insertion of such a membrane, the surgical general field isolation dam which allows isolation of soft tissues extending to the muco-gingival junction will satisfy the requirements of isolation for such a procedure.

Prosthodontics

The general field isolation dams of the present invention will significantly improve the quality of prosthodontic treatment. The major shortcoming of the conventional rubber dam technique is that it generally provides access to instrumentation of the clinical crowns of the teeth, thereby preventing any subgingival access for instrumentation and ruling out prosthetic procedures from rubber dam isolation. With this new technique, all phases of prosthetic procedures, from the preparation phase, through the retraction and impression phase, to the fabrication of provisional temporary restorations, and the final seating of the prosthesis will be benefited. This is true whether the type of restoration to be fabricated is a single crown, multiple crowns, conventional bridge, Maryland Bridge, onlay, ¾ crown, anterior porcelain fused-to-metal crowns, porcelain jacket crowns, CAD CAM computer generated ceramic crowns, onlays, implant-supported crowns or bridges, base-ups for badly deteriorated teeth in the preparation phase of crown preparation cast post and core fabrication and placement, and other future prosthetic procedures as of yet to be thought of.

Orthodontics

Application of the conventional rubber dam technique to orthodontics has been virtually impossible due to the cumbersome need to floss the rubber dam septa through countless contacts between teeth in a whole arch. Often some teeth have not yet erupted fully, others are malposed, and contact points are absent in some cases. The young orthodontic patient or even an adult patient could not easily stand the trauma of the application of the dam, let alone its application followed by bracketing, bonding of brackets, and then wire placement. The general field isolation rubber dam may significantly change the way orthodontics is practiced. With the ease of application of the rubber dam to the whole arch, and specialized design features for orthodontic dams, the bonding strength of brackets may be significantly improved. The orthodontic general field rubber dam with an integrally applied barrier adhesive will allow the clinician to quickly apply the dam as a whole unit, ready for the treatment phase almost immediately. In addition, since orthodontists take study models to review the dentition prior to treatment, the general field isolation dam can be prepared on the model to the specifications of the clinician with regard to the anatomical details of arch length and tissue contours prior to insertion.

Oral Surgery/Oral Pathology

Almost all oral surgical techniques will continue to be performed without the new technique, with the possible exception of the placement of dental implants, which are becoming popular as a new treatment modality. It should be noted that patients who have undergone surgical removal of neoplasms and diseased tissues of the mandible, maxilla, and oropharyngeal complex also often require implants to retain a prosthesis designed to restore the form of anatomical structures lost by surgical intervention. The surgical general field isolation dam may be instrumental in isolating difficult anatomical structures for a variety of surgical applications.

Implantology

As discussed earlier, both in the prosthetic and oral surgery sections, the general field isolation dams will have a significant effect on the placement of implants and implant prosthetic procedures which follow the healing process of the implant supported prosthesis. These new techniques require the handling and placement of minute components to complete the procedures. This raises the possibility of implant components being dropped accidentally during the procedures and subsequent swallowing or aspiration by the patient. Current procedures in this area are routinely performed without the use of the rubber dam. The general field isolation rubber dam may be of great value in protecting the patient and the dentist from this unpredictable unfortunate risk that is an inherent byproduct of this new treatment modality. It is an absolute requirement of the dentist using the general field isolation dam in circumstances where small components are used, to apply the general field isolation meticulously and make sure that an adhesive barrier material is applied to hermetically seal the entire circumference of the operative perimeter at the dam-tissue interface. The dam must be stabilized with a high degree of certainty by the clinician in order to realize all of the benefits of the use of the rubber dam in controlling the risks inherent in these techniques.

CAD-CAM and The Computer Generated Dental Restoration

CAD-CAM (computer aided design and computer integrated manufacture) is the creation of dental restorations almost instantaneously with the use of an imaging unit to take digital impressions of the contours of a prepared tooth and surrounding teeth and then computer generate the necessary dimensions and contours of a completed restoration, and then mill the specified restoration from a block of ceramic material in a manner of minutes. This process requires a process of the sintering of a metal power onto the preparation or indirectly onto a model in order for the imaging to properly detect the contours of the preparation and surrounding teeth for insertion of the data into the computer. In order to apply the layer and obtain a quality digital image, saliva and moisture must be eliminated from the operative site. The general field isolation rubber dam will be of great value in isolating the operative field for this technique of optical imaging as a substitute for conventional impression techniques. In addition, the general field isolation will serve equally well in the insertion phase and bonding of these ceramic restorations in place once they are fabricated by the CNC milling process.

Emergency Dentistry

General field isolation dams of the present invention will be of great value in quickly isolating oral structures in emergency circumstances. Dental emergencies present with a variety of requirements for instrumentation. Very often, the emergency patient is an unscheduled interruption in the dentist's schedule and the dentist has a limited amount of time to address the problem that the patient is having so that he can go back to treat his patients previously scheduled and already involved in their treatment. A quick but effective isolation device is required in this type of circumstance. The general field isolation dam with an integrally applied adhesive will fulfill the needs of this type of circumstance.

Often, hospital emergency personnel in emergency rooms see dental emergencies of a traumatic nature. Unskilled and inexperienced with the conventional rubber dam application, and in short supply of time to attend to the patient's needs, the general field isolation dam with either the surgical ties or the integrally applied barrier adhesive is a quick, effective solution to the isolation or oral structures in emergency circumstances.

Dental Research

General field isolation dams will have applications in dental research in many ways. Certainly, human clinical trials in gathering research data about new devices, medications, and techniques will benefit from the control of such contaminates as salivary secretions and oral microbial flora during the experimental application of these materials. The introduction of membranes designed to stimulate tissue regeneration in the supporting structures of the teeth, bone and soft tissue grafting, the studies of osseointegration with the introduction of new implant technologies are but a few to name.

The other research application for general field isolation dams are the in vitro studies in animals. Most current animal research in dentistry is carried out without the application of a barrier to the same factors encountered in human trials. Use of the conventional rubber dam is not possible in canine studies because the morphology of canine teeth differs widely from that of the human dentition. Canine teeth are largely thin triangular or trapezoidal structures, without any contacts between them as in human teeth. In addition, their morphology is not amenable to the application of clamps or conventional retaining devices. The general field isolation approach to isolating whole operative sites simultaneously, however, will be adaptable to the canine anatomy. Surgical dams with surgical “T” ties or integrally applied pressure sensitive adhesives will be able to be readily applied to the anesthetized canine subject. This adaptability of the general field isolation dam to non-human anatomical variations, will allow the technique to be applied not only to other research areas involving canine or other animal subjects, but will fill a need in the area of veterinary dentistry and medicine.

Non-Dental Surgery

The historical literature reports use of the rubber dam in several types of non-dental surgery. Rubber dam was recommended by Shafiroff et al. to atraumatically retract soft tissues to allow severed bone ends to be trimmed before attempted replantation surgery. In urology, rubber dam has been used to isolate the cut ends of the vas deferens, during asectomy reversal. The benefits of rubber dam have recently been confirmed following extensive bowel resection, as a barrier to peritoneal spread of infection, and in reducing the incidence of adhesions.

The general field isolation rubber dam, with its moldable operative perimeter which adapts to highly irregular anatomical contours, will have an expanded role in all types of non-dental surgical procedures. Specialists in ENT (ear, nose, and throat) will have an isolation aid which adapts to highly irregular anatomical site such as cleft palate closure, oronasal defects secondary to trauma or neoplastic disease, and reconstructive surgical techniques to restore lost anatomic structures. Plastic surgeons will have a barrier device and retraction aid that will mold itself to facial contours in reconstructive surgery of all kinds. Orthopedic surgeons will benefit from the general field isolation dam's characteristics of anatomical adaptation, control of moisture and microbial contamination of the work site, and retraction of soft tissues as applied to procedures of all types. Application of the general field isolation rubber dam to non-dental surgical techniques will be limited only by the imagination of the surgical community.

Modified Field Isolation Rubber Dam Clamps

The effective design of rubber dam clamps for general field isolation of the operative site must fulfill three major requirements in order to be effective: First, they must allow the rubber dam membrane to come into intimate contact with the teeth and soft tissues of the alveolar arch in order to effectively seal the tissue-dam interface in order to prevent the percolation of fluids through to the operative work site (i.e. the creation of an impermeable seal at this interface, if possible); second, they must retract the rubber dam membrane in a cervical direction to expose not only the teeth, but also the associated soft tissues, for adequate visibility and ease of instrumentation below the gumline; and third, they must support the rubber dam from displacement by the tensile forces exerted upon it by the stretching of the resilient material by the rubber dam frame.

The summation of the effectiveness of an externally applied rubber clamp on a rubber dam membrane to achieve these three desired traits of general field isolation of an operative site, or of an internal, integral mechanism within a rubber dam membrane to achieve the same result, may be summarized by an analysis of the resultant vector forces applied to the membrane by the design of the device. If the component vector forces are measured by their magnitude of displacement according to either “X” or “Y” coordinates, with a displacement in an X direction being generally perpendicular and in a direction away from the longitudinal axes of the teeth in 5 an arch, and a displacement in a Y directional coordinate being generally parallel to the long axes of the teeth and in a cervical direction away from the gumline or the interface between the clinical crowns of the teeth in a cervical direction (toward the end of the roots of the teeth), then the overall effectiveness of a field isolation device of any type can judged to be generally undesirable if it promotes a significant displacement of the rubber dam membrane in the X coordinate direction, thereby pulling the edge of the membrane away from the teeth and gingiva and opening a gap for the percolation of fluids, thereby reducing the effectiveness of the membrane as an isolation barrier and compromising the integrity of the operative site. U.S. Pat. No. 5,503,556, and the similar product, Bond Buddy, previously described, each retract the rubber dam membrane in a purely X coordinate direction away from the hard and soft tissues of the alveolar arch and therefore would be judged as quite undesirable designs for general field isolation of the alveolar arch. Neither product proposes a mechanism for the closure of the gap created, thereby insuring that fluids will inevitably percolate through to the operative site, and materials and debris will fall through to the patient's oral cavity beneath the membrane. The most ideal design of a field isolation rubber dam membrane or apparatus is one which create an hermetic seal around the entire periphery of the operative site to be isolated. This ideal clinical result, is one in which the X component of displacement of the rubber dam away from the tissues is effectively “zero”, which would mean that the rubber dam is in perfect contact with the alveolar arch. The other criterion of measurement of effectiveness of the retraction of the rubber dam membrane at the tissue-dam interface is the displacement of the rubber dam margin in a cervical direction, thereby exposing the associated soft tissues of the site to be isolated to visualization and instrumentation for the procedure proposed by the clinician. The design of U.S. Pat. No. 5,503,556 and the similarly designed Bond Buddy product again fall short in this respect, retracting the rubber dam membrane essentially only to the level of the gumline and not beyond. This is because the body of the clamp, which retracts the rubber dam membrane, is designed in a planar configuration coincidental to the plane in which the clamping mechanism is located. An effective design of a general field isolation rubber dam clamp for dental isolation purposes, therefore, is one which retracts the rubber dam membrane in such a manner that the X component of displacement is either zero, or is absolutely minimized, thereby allowing the dam to seal itself at the tissue-dam interface, and also retracts the rubber dam along Y coordinates in a cervical direction and magnitude which the clinician requires for proper visualization and instrumentation. It should be noted that although many effective clamp designs may have some slight component which might promote lateral displacement, vector forces inherent in the resiliently stretched rubber dam membrane, or forces applied to the rubber dam membrane by an operative insert integrally designed into the membrane in order to control its extensions and displacement, may counteract any vector forces of lateral displacement by the clamp, thereby nullifying the tendency of the membrane to be pulled away from the tissues of the alveolar arch. Simply stated, the opposing vector forces of the two interacting field isolation devices cancel each other out, allowing an intact seal at the tissue-dam interface. It cannot be overlooked that due to some extreme anatomical configurations, any field isolation membrane or device may fall short of providing the ideal tissue-dam interface. It is for this reason that intermediate barrier agents may either be applied manually or may be integrally designed into field isolation rubber dam membranes to fill the gap or to perfect the seal. These intermediate agents are discussed in the text of this patent disclosure in depth in other sections and will not be repeated here.

The effectiveness of modified rubber dam clamps for general field isolation of the alveolar arch may be analyzed by a consideration of the resultant vector forces applied to the membrane by the clamp. If the resultant vector force is broken down into its “X” and “Y” coordinates, an unfavorable resultant force can be said to be one which has an X component of a large magnitude, displacing the membrane away from the alveolar tissues, thereby opening a gap to allow the percolation of fluids between the operative site and the patient's oral cavity. A favorable resultant force is one which displaces the membrane downward in a cervical direction, without simultaneously displacing the membrane away from the soft tissues.

Any attempt to retract the rubber dam membrane in a cervical direction will be accompanied by some tendency toward lateral displacement, a problem aggravated by the laterally displacing forces of the membrane stretched over an external rubber dam framework. This tendency for lateral displacement may be countered by opposite directional tensile forces of the resilient membrane stretched around the operative site, or by forces applied to the membrane by the integral operative insert, for example, a wire loop, designed within it.

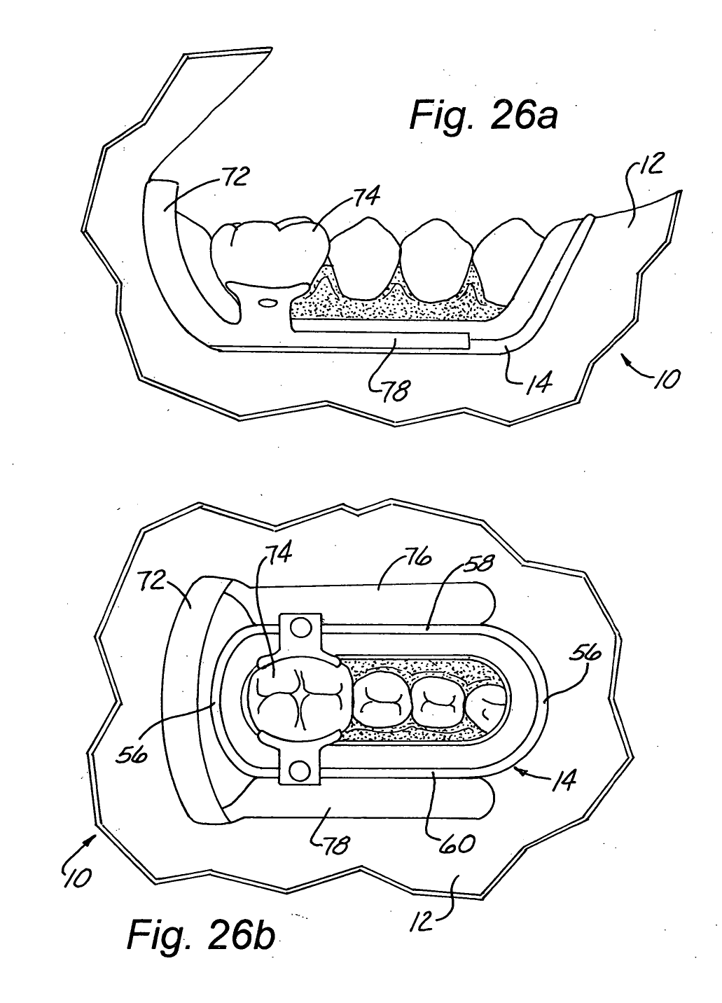

FIGS. 26a and 2b illustrate the relationship between a rubber dam clamp 72 and a general field isolation dam 10 of the present invention. The clamp 72 attaches to the base of a tooth 74 near the gumline and includes a pair of extended arms 76 and 78 which are located below the gumline. The arms 76 and 78 are positioned closely adjacent to the lingual bow 60 and labial bow 58 of the deformed operative insert 14 and accordingly assist in resisting the tensile forces in the rubber dam membrane 12 and holding the dam 10 in its desired location.

Precautions for Use of the General Field Isolation Rubber Dam

Currently only about 10% of all practicing dentists use the rubber dam in clinical practice. It is anticipated that this percentage will continue using the conventional rubber dam application. With an attrition rate of 90%, the introduction of this new isolation modality should be compared to practicing in the complete absence of a rubber dam, instead of comparing it to the adequacy of the existing technique. The general field isolation rubber dam technique is useful in those circumstances where it is not possible to apply the conventional rubber dam, or when instrumentation is required below the gum line. The clinician has a choice as to whether to apply the field isolation rubber dam with or without a barrier seal. Whenever any minute hand-held instruments or components are used, such as in implant components, a moisture-proof seal at the tissue-dam interface must be perfected by the use of a barrier material. This intact seal must be determined by the clinician to be moisture-proof and impervious to the seepage of fluids and foreign bodies through the interface. A second line-of-defense to the dropping of foreign bodies during the course of a procedure, which should be employed, is to ligate small hand-held instruments and components, often with a piece of dental floss, prior to use. While the construction of many general field isolation rubber dams will be of latex, other polymeric materials, such as silicone, vinyl, neoprene, polyurethane, or others, may be substituted in certain circumstances for their alternative physical characteristics, or for properties which accommodate to manufacturing techniques. Any general field isolation rubber dams manufactured of latex will have the same properties of allergenicity that any standard medically approved latex product as specified by the Food and Drug Administration as being an acceptable composition for the construction of medical devices. It is incumbent upon the clinician to detect in a thorough health history and to ascertain by questioning, any tendency of a patient a general atopic susceptibility to allergens, and specifically any prior contact dermatitis or anaphylactic allergic reaction to latex. Clinical consideration should be given as to whether field isolation rubber dams should be applied in circumstances of very high anxiety levels, patients prone to panic attack, those who experience claustrophobia with a rubber dam, or have uncontrollable tongue thrusting movements, or breathing difficulties such as asthma, chronic sinusitis, chronic obstructive pulmonary disease, emphysema, or other obstructions which would compromise their breathing with a rubber dam in place. General field isolation rubber dams are not designed for the prevention of disease. The primary purpose of this alternative modality of isolation of the oral site is to create an operative work site for the clinician in which optimal dental restorative techniques may be performed.

General Field Isolation of an Entire Arch for Orthodontic Treatment Purposes

It is possible to isolate an entire arch of teeth with the general field isolation rubber dam for orthodontic purposes such as bonding brackets to prepare for the insertion of an arch wire. The design of an orthodontic dam requires an operative framework insert which is generally elliptical, or “U” shaped, or “V” shaped, to accommodate the different anatomical variations of arch forms. In addition, dams of differing sizes will be commercially available to accommodate different sized arches. It is important to remember that with the highly moldable operative framework, it is possible to make custom adaptations to different arches from the standard available commercial forms and sizes. This allows the orthodontist maximum flexibility in adapting the dam to the circumstance.

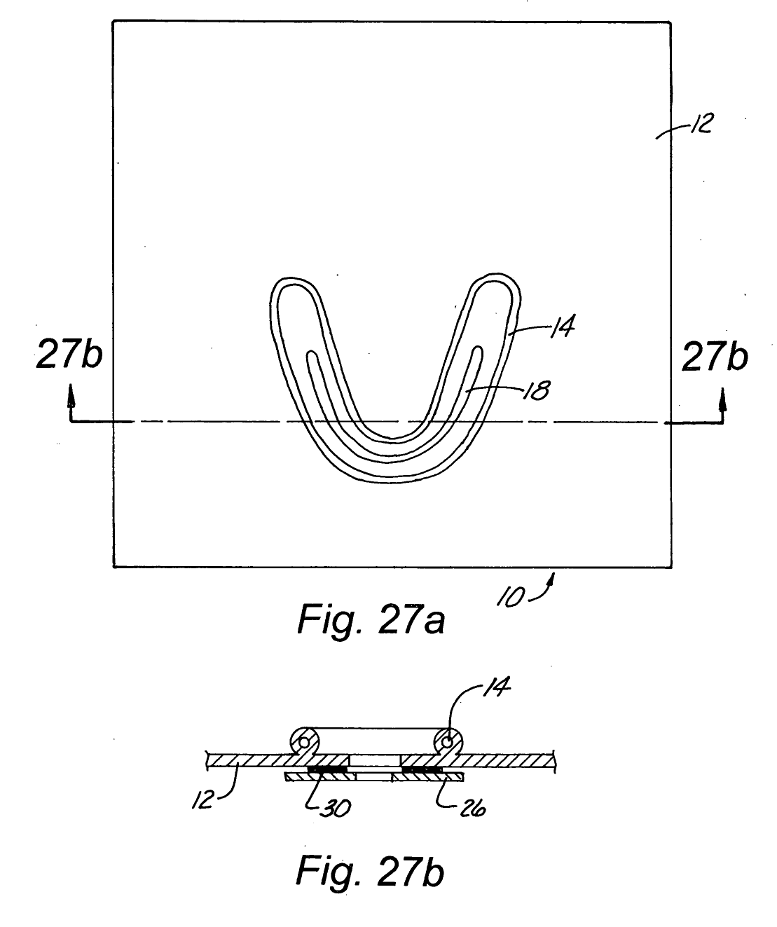

The orthodontic dam 10 is designed with an internal wire or stamping insert 14 which is purposely designed to be longer than any typical arch length. It is also designed with a central slotted opening 18 which is purposefully shorter than is required for a typical arch of teeth (FIGS. 27a and 27b). Each orthodontic dam 10 must be customized by the clinician to fit the anatomical details of the arch to be isolated. Since orthodontists always prepare study models before beginning treatment, the dam chosen for the application can be compared to the arch length and form outside of the mouth and completely customized prior to insertion into the mouth. By comparing the central opening 18 of the commercially prepared dam to the arch length of the teeth to be isolated, the clinician can calculate the amount of lengthening that the central opening will need to exactly fit the whole arch. This lengthening can be accomplished by using a rubber dam punch which is set to punch the largest hole, then punching a series of overlapping holes to lengthen the slotted opening. When both sides of the arch are lengthened sufficiently and checked on the study models for accuracy, the dam 10 is ready for molding to prepare it for insertion. In order to do this, the distal ends of the operative perimeter are turned up to a 45 degree angle. If there is significant excess distal perimeter, the distal ends are bent further to a substantially open “U” configuration, to mimic the posterior contour of the rubber dam clamp which is to retain it. This excess distal framework then follows the natural form of the rubber dam as it is stretched around the clamp and proceeds in the direction of the membrane as it returns to the rubber dam frame extraorally.

The orthodontic dam should be retained by a combination of bilaterally placed rubber dam clamps and ideally, an integrally applied pressure sensitive adhesive barrier material. The placement of rubber dam clamps may interfere with banding the most posterior molars with the band/buccal tube assembly. There are ways to accommodate the banding of these molars without the interference of the rubber dam clamps. The first possibility is to band the molars before the application of the rubber dam. This would be followed with the dam being applied and the clamps being placed after the cement for the bands is set up. The major reason for placing the dam is to improve the moisture environment during the bonding of the brackets. The second possibility is to clamp the most posterior molars with a special clamp, HuFriedy #BAD, with a transverse arch that is placed distally of the tooth to be clamped so that work may be performed in an unobstructed manner on the tooth being clamped. The third possibility is to apply a general field isolation rubber dam with an enhanced barrier adhesive which will retain itself without any rubber dam clamps at all. Whatever the technique used to retain the dam, a barrier material must be applied to perfect the moisture seal before beginning the procedure. If the dam does not have an integrally applied adhesive, the clinician must apply a putty, paste, or gel barrier material around the entire periphery to seal the entire perimeter to prevent leakage of saliva into the operative field or prevent the dropping of small components such as brackets from slipping through the tissue-dam interface. When used conscientiously, the orthodontic dam will prove to be an invaluable aid in the bonding of brackets and other orthodontic needs for the clinician. An intact adhesive barrier seal must be maintained in order for the orthodontic dam to function optimally.

Isolation of an Anterior Segment or the Anterior Half Arch with the Resilient and Deformable Field Isolation Rubber Dam Using Reciprocal Inter-arch Forces for Retention and Mandibular Retraction

The resilient and deformable field isolation rubber dam for isolation of the anterior segment or the anterior half arch may be manufactured in a flat form without the type of diaphragm that the reciprocal whole arch field isolation rubber dam requires. This is because the application is confined to a much more anterior location in the oral cavity, still allowing room for the patient's tongue and not encroaching upon the interior oral cavity to the degree that the whole arch application does. With placement of the anterior dam out of reach of areas where the gag reflex is triggered, the patient is able to tolerate the intrusion of the rubber dam. Although the anterior resilient interarch rubber dam may be manufactured in a flat form, it also may be manufactured on a three dimensional die, to eliminate or minimize the need for bending of the resilient and deformable operative insert. The molding die would be generally a rounded or somewhat square-ended wedge shaped form. As previously mentioned, no “cut-out” concavity needs to be fabricated into this dam, but it is not inconceivable that some clinicians might prefer this alternative embodiment.

Some preparation of the flat resilient and deformable anterior field isolation rubber dam is necessary before insertion. The arcuate central opening will be fabricated in a shorter form than is necessary, so that the operator may use the rubber dam punch to lengthen the slit in order to customize the dam to the intended application. Once the length of the central opening is complete, the clinician has the option of either bending the dam into a simple rounded “U” shaped configuration in order to insert it, or bending the operative insert in a more rectilinear manner at a 45 degree angle with the labial and lingual bows, creating a “V” shape. The more squared, rectilinear form is slightly more efficient at preventing material from encroaching on the interior oral cavity. Either approach is acceptable, however, and will be a matter of preference of the clinician. It should be noted, that if these dams are fabricated on molding dies, either pattern of form is acceptable for their manufacture. In addition, if the resilient interarch dam is injection molded on three dimensional molds with plastic or composite operative inserts which act predominantly in a rigid or somewhat elastic, reboundable manner, this substitution of material composition should be considered to be within the spirit and scope of this disclosure. This type of anterior interarch dam may be manufactured without an integral framework, or may have an integrally attached frame of malleable, resilient, or rigid material composition.

Isolation of the Distal Edentulous Quadrant or a Posterior Segment or Quadrant with Grossly Carious Teeth Precluding the Use of Rubber Dam Clamps with the Resilient and Deformable Field Isolation Dam

Isolation of a posterior quadrant of teeth that are so badly broken down due to disease that a rubber dam clamp cannot be applied can be accomplished with a resilient and deformable rubber dam designed for posterior application. These methods also apply to a quadrant that is edentulous in the posterior areas (the back teeth have previously been extracted and just a bare ridge remains).

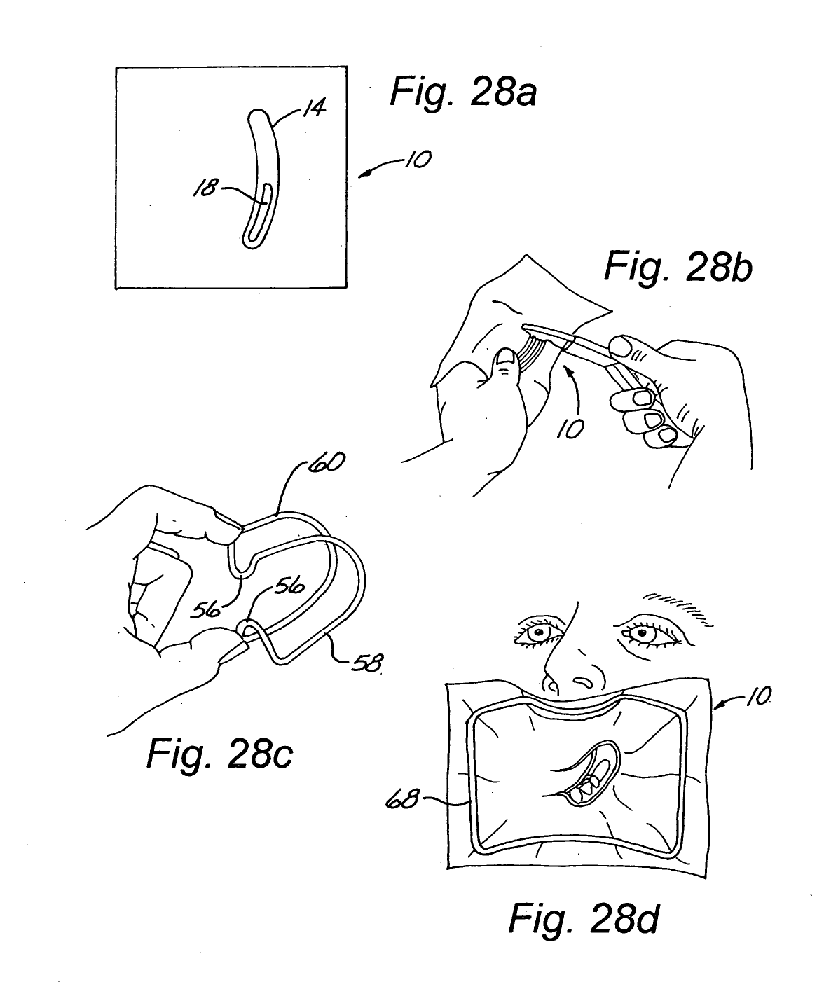

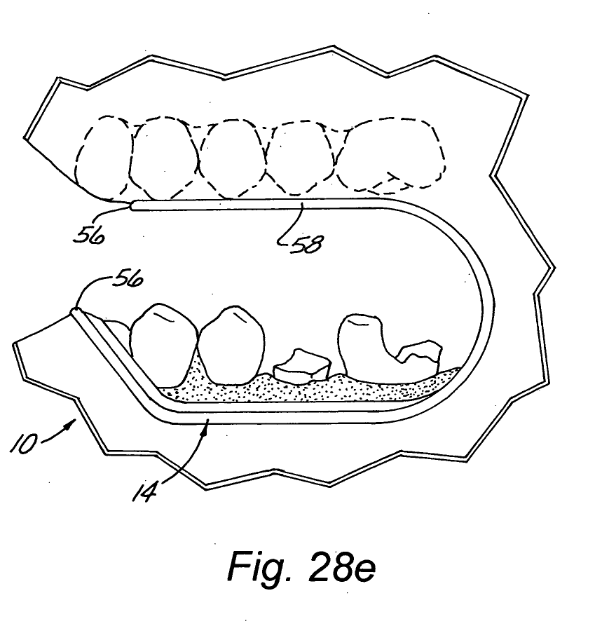

The technique consists of selecting the appropriate posterior resilient and deformable rubber dam 10 (FIG. 28a). This dam 10 has a resilient operative insert 14 which can be bent from a flat shape into a generally “U” shape wherein a lingual bow 60 and a facial bow 58 are linked by a pair of transverse arches 56 (FIGS. 28b and 28c, which depicts the insert without the rubber dam membrane 12 for clarity) for insertion into the mouth over the quadrant to be exposed (FIG. 28d). Note that in this embodiment and application, one of the transverse arches spans upper teeth while the other transverse arch spans lower teeth. An enlarged side view is illustrated in FIG. 28e wherein the dam is being used to isolate a quadrant of badly broken down teeth without the use of rubber dam clamps. Since the dam 10 resists deflection from its flat configuration, it seeks to open to its original tempered configuration. (Heat-treating of a metal such as an appropriate alloy of stainless steel, causes a memory in the wire which imparts resiliency by setting the crystalline matrix of the metal in the form in which it is in at the time of firing. Plastics and composites and other materials may behave in a similar manner through another physical process and chemistry.) Reciprocal forces between the operative insert and the patient's muscles of mastication as transmitted through the maxilla and mandible seeking closure retain the rubber dam in place without the need for rubber dam clamps. In addition, pressure sensitive adhesives or chemically activated adhesives or photo-activated adhesives may be integrally applied or manually applied in order to adjunctively seal and retain this rubber dam. The primary retention, however, is the reciprocal force applied by the resilient insert.

Preparation of the posterior interarch dam begins by the clinician bending the anterior end of the oblong operative insert at approximately a 45 degree angle to form a transverse arch 56 (FIG. 28c) which will link the labial and lingual bows and allow these elements of the operative insert to seat on the soft tissues at a level which will expose not only the teeth to be worked on, but also the adjacent soft tissues (FIG. 28b). The central opening 18 of the dam overlies the area of the dentition that the clinician seeks to expose and isolate. The dam 10 provides a generally elliptical or oval slot for exposure of the teeth or the edentulous area. Since the teeth, presumably are so badly broken down, simple holes punched into a dam would not suffice for their exposure. The dam would simply constrict over the stumps of the teeth, obscuring them and frustrating the efforts of the dentist to isolate them. Even if a single arch is to be isolated, it is still advisable (although not absolutely necessary) to bend the other end of the operative insert to form a second transverse arch 56 in the opposing arch (FIG. 28c). The teeth in the opposing arch are not to be isolated, but that end of the insert serves to rest over the occlusal surfaces of the teeth in order to generate the opposing reciprocal forces. Some stability of the insert is gained if a transverse arch 56 is formed. The ultimate preparation of this dam 10 is at the discretion of the clinician. It should be noted that the fabrication of the central openings 18 is shorter than what will be necessary for isolation of a given site. This is so that the clinician may customize the dam 10 for each application by using the rubber dam punch that lengthens the slit or central opening 18.

The clinical technique of isolating both an upper and a lower quadrant at the same time with the resilient and deformable posterior field isolation rubber dam is almost identical to that already discussed. In this case, a central opening is present on both ends of the operative insert. There is a protracted interocclusal specification of distance between the central areas to accommodate for the interocclusal distance of the patient's mouth fully opened.

With the dam in place, badly broken down teeth may be endodontically instrumented, gross caries removed, restorative posts and pins placed, base-ups placed, temporary or permanent crowns placed, and a host of other procedures accomplished. In the distally edentulous arch, implants may be surgically placed with this type of rubber dam, or implant prosthetics accomplished.

The Resilient and Deformable Whole-arch Rubber Dam Retained by Inter-arch Reciprocal Forces

The quest for an effective appliance like a rubber dam, which will not only isolate a whole arch of teeth, but do so without the need for rubber dam clamps, has eluded dentists in the past. Many attempts have been made to create a whole-arch rubber dam device, but all of these attempts have been unsuccessful for similar reasons. Three references in the prior art of patent literature are exemplary of these prior art attempts. All three share common design defects which condemn the devices to failure in the dental art. The three devices listed for discussion are U.S. Pat. No. 4,600,387, U.S. Pat. No. 5,078,604, and German Patent Number DE19704904C.

The '387 device and the '604 device are identical in every respect with regard to design, with the exception of the manner in which they attach to a rubber dam membrane. Each share the same design deficiencies that are also found in Oscar Malmin's barrier drape apparatus. First, all three devices are generally two-dimensional “flat-plane” designs, trying to solve a complex three-dimensional isolation problem. They all essentially “fold in half about a midline axis” for insertion into the oral cavity. In doing so, they ignore the fact that the central diaphragm of rubber dam material will be carried so far back into the patient's interior oral cavity, that it will obstruct the tongue and throat of the patient, elicit the gag reflex of the patient, cause choking and an interruption of dental treatment, and a failure of the isolation device. The second design defect of these barrier appliance, is that they fail to take into account the substantial interarch distance between the maxillary and mandibular alveolar arches of teeth when the mouth is fully opened. These devices pivot about an axis that would be located within about a centimeter behind the last tooth to be isolated. In actual human anatomy, the upper and lower teeth upon disclusion separate upon opening in a generally parallel fashion slightly arcuate, with the real axis of rotation of the mandible with respect to the maxilla being at the temperomandibular joint, located 4-5 inches away from the occlusal planes of the teeth. Any design of a successful appliance to isolate the whole alveolar arch of teeth must take these factors into account in order to be clinically useful and commercially successful.

The design of a reciprocal rubber dam appliance to isolate an entire alveolar arch of teeth by reciprocal forces must describe a three dimensional solution to the three-dimensional requirements of the oral cavity in this circumstance. For this reason, a flat-plane rubber dam membrane cannot satisfy the requirements placed upon it in this isolation circumstance. Instead, the reciprocal whole-arch rubber dam appliance must be molded on a three-dimensional die or molding element which is either a generally rounded wedge shape or a generally rounded pyramidal form, or a generally rounded conical form, with a centrally located concavity for forming a concave interior diaphragm relieving the impingement of excess rubber dam material in the patient's interior oral cavity. The design of the mold must anticipate and slightly exceed the dimensions of interarch distance and angulation of the teeth with respect to each other when the mouth is in a fully opened position. The fabricated rubber dam device will be imparted with a resiliency and/or deformability in order to adapt to each person's individual anatomical requirements, but the initial configuration of the mold and subsequent device must fall within certain limits in order to be inserted and retained in comfort by the patient. The operative insert which integrates with the rubber darn membrane must be imbued with the qualities of resiliency and/or deformability in order to be clinically useful. The reciprocal forces of mastication are applied to the resilient appliance, and are resisted by the appliance in order to create (1) the action of a mouth prop to keep the patient's mouth in an open position during treatment, (2) a general retention of the appliance in place intra-orally by reciprocal forces applied to it, and three (3) proper seating of the operative insert over the alveolar arch to be isolated, even without the use of adjunctive adhesives (although these appliances may have integrally applied pressure sensitive adhesives, or other types of adhesives, a really excellent design will allow a whole arch application without the addition of any retentive adhesive or barrier adhesive at all. The whole arch reciprocally retained rubber dam may be fabricated without an integral frame, with the intention of the end-user stretching the rubber dam membrane over a standard or improved field isolation rubber dam frame which is a separate device. It is the opinion of the inventor that this will be the most clinically useful embodiment, because the clinician can variably adjust the tension on the rubber dam membrane in all directions in order to adequately retract the patient's lips and cheeks. Another embodiment, the design of this rubber dam with an integral frame of either malleable, resilient, or rigid material, should be considered to be within the scope of this disclosure.

The most likely clinical application of this type of whole arch general field isolation rubber dam is in the field of orthodontics. An appliance which may be inserted intra-orally without any prior preparation by the orthodontist, isolates an entire arch of teeth, controls moisture of saliva and the humidity of the patient's breath, does not require auxiliary retention by the use of rubber dam clamps, adequately retracts the patient's lips and cheeks, and props the patient's mouth open for adequate access for instrumentation, will be a substantial clinical contribution to orthodontic treatment. This type of rubber dam, which doesn't require rubber dam clamps to retain it in position, will allow the orthodontist to place orthodontic bands with buccal tubes on the most distal molars without obstruction. This is critical, since a rubber dam clamp is usually applied to the last tooth in the arch and therefore would be an obstruction if a band needs to be applied to the same tooth. A whole arch orthodontic rubber dam appliance will also be critically useful, because it will create a superior moisture-free environment for the bonding of brackets to the teeth. Bonding strengths are often compromised when there is moisture contamination. A whole arch rubber dam appliance which is easy to use and comfortable to the patient will be a valuable adjunct to clinical practice.

It should not be overlooked that the whole-arch reciprocally retained field isolation rubber dam appliance may also be applied to whole arch prosthetic reconstruction, or to any other area of dental treatment. These reciprocally retained rubber dams may or may not be fabricated with integrally applied barrier adhesives to perfect the moisture seal at the tissue-dam interface. They might also be fabricated for the addition of manually applied barrier adhesives.

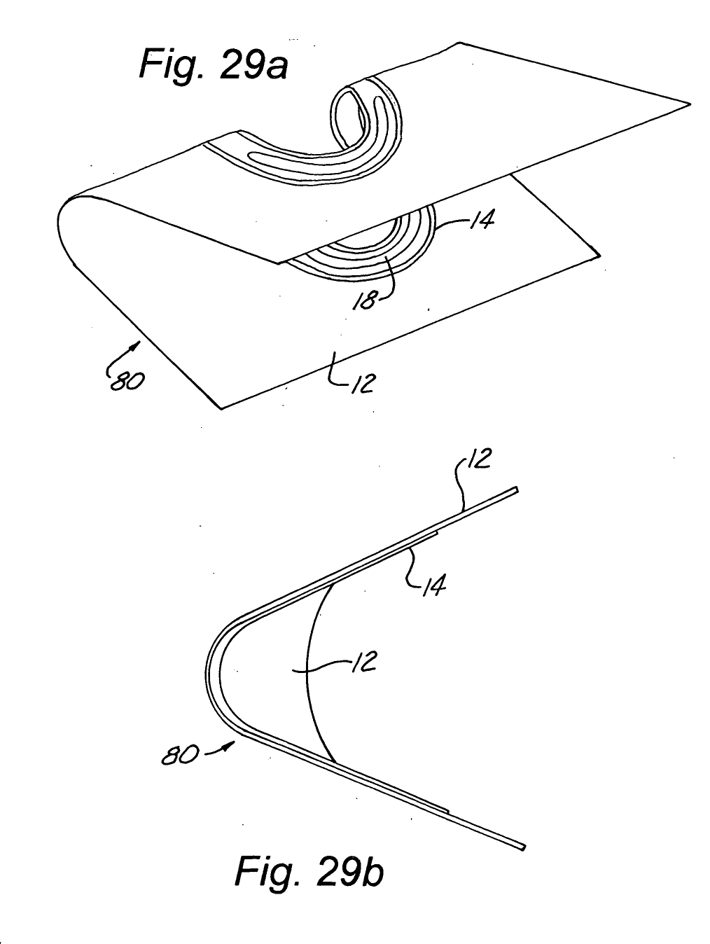

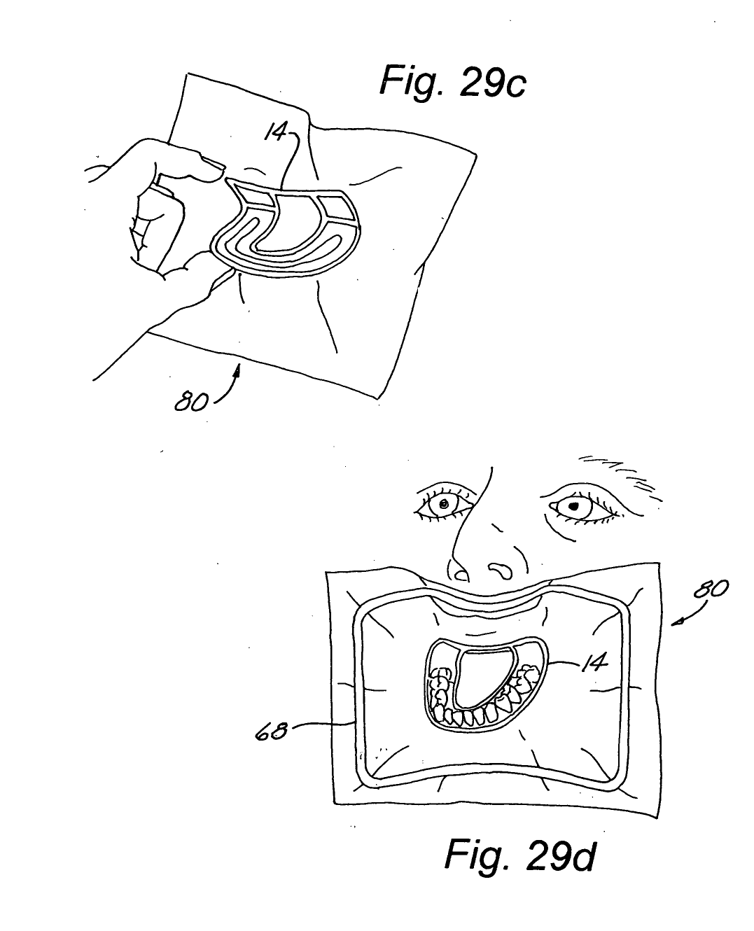

An embodiment of the present invention suitable for use as a whole-arch reciprocally retained field isolation rubber dam is illustrated in FIGS. 29a-29d, generally at 80. The dam 80 is preferably preformed with a resilient and deformable insert 14 in a saddle-shape that is slightly more open than the patient's mouth can comfortably accommodate so that it is compressed upon insertion so that the resilient insert 14 will exert an opening force on the patient's mouth. As illustrated in FIG. 29c, the clinician will compress the dam 10 with his or her fingers to aid in insertion of the dam 10 in the mouth of the patient. The inserted dam 10 will expose the whole arch of the patient's teeth and may be further secured to a rubber dam frame 68 (FIG. 29d). The resilient insert 14 will act to hold the dam 10 in place without the need for rubber dam clamps, barriers, adhesives, or the like, in many clinical circumstances.

General Field Isolation Surgical Rubber Dams and Methods of Isolation of Operative Surgical Sites with Highly Irregular Anatomic Contours and Boundaries

In stark contrast to general medical surgical practice, all oral surgery has traditionally been performed in the complete absence of a rubber dam or barrier drape. Local tissue resistance and immunological factors present in the salivary fluids secreted by the submandibular, sublingual, and submental glands have undoubtedly compensated for the massive microbial exposure of tissues exposed by invasive surgical procedures. Advances in periodontal therapy, such as guided tissue regeneration, and the placement of implants and their components are challenging old concepts of asepsis and are increasing the requirements for microbial control to optimize the outcome of these new procedures. In addition, cleft lip and cleft palatal defects involving the oral cavity and the nasopharyngeal complex are candidates for a vastly improved isolation technique. A general field isolation rubber dam or barrier drape that is truly effective at isolating an oral operative site and retract the distracting influence of soft tissues such as the lips, cheeks, and tongue during instrumentation is needed, but until now hasn't been developed.

The surgical general field isolation dam is constructed with a continuous metal stamping or wire insert which is embedded in latex, or neoprene, or other polymer membrane material, with surgical ties which are “T” shaped projections pointing inwardly from around the peripheral border of the operative perimeter. Isolation of a highly irregular anatomic operative site is accomplished by bending and conforming the soft, highly malleable metal substructure of the operative perimeter to the three dimensional anatomical features of the proposed operative site. The “T” shaped metal projections allow a surgeon to suture the dam in place in areas remote from the teeth and gingival tissues, to expose an operative site which is extended to accommodate tissue flap procedures which expose not only the teeth, but their root structure and associated areas of bony support.

Anchorage of the surgical dam with rubber dam clamps applied in the usual manner of retention are augmented by suturing as indicated in a typical periodontal surgery requiring a full flap technique where there are teeth present in the operative site. Isolation of completely edentulous areas (areas where all teeth have been lost due to disease) or highly irregular anatomic operative sites such as cleft palate closure, oronasal defects secondary to trauma or neoplastic disease or any other such highly irregular operative surgical site may rely on suturing as the exclusive retention of the dam. It should not be overlooked that the suturing technique may be augmented by an integrally applied mucosal tissue adhesive such as methylcyanoacrylate or other such agent to add to the continuity of the moisture seal of the surgical dam or may suffice in and of itself as a means of retention and barrier seal to the operative perimeter of a surgical dam.

A Hybrid Approach to General Field Isolation Utilizing the Continuous Membrane Dam and the Slit-Dam Method of Field Isolation

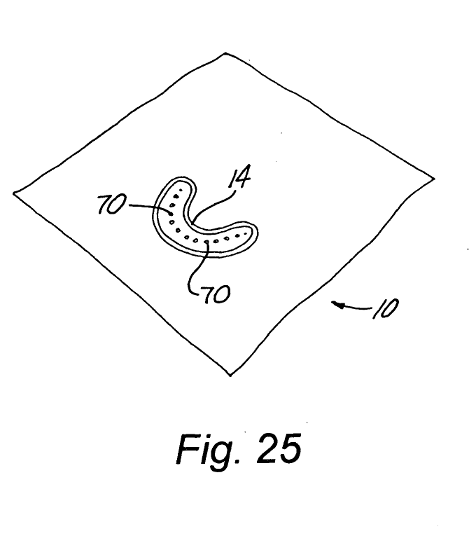

The continuous membrane general field isolation dam can be of great benefit to the clinician who desires a completely customized approach to general field isolation. This embodiment of the dam 10 employs a continuous membrane 16 within the operative perimeter bounded by the wire insert 14 and is thereby lacking the central opening that the other general field isolation dams have to automatically allow the teeth and tissues to be isolated as a unit (FIG. 25).

This approach employs the conventional technique of punching individual holes 70 for all of the teeth to be isolated first; then identifying the specific teeth that will need to be isolated along with their soft tissues for more subgingival access. To accomplish this, the dentist cuts a slit-like opening in the membrane with a scissors by cutting between the holes that have been punched, until only the specifically chosen teeth will insert through a slit-like opening. The dam is then inserted over all the teeth to be isolated, flossing the rubber septa between individually isolated teeth. The labial and lingual bows on the wire perimeter are then bent to retract the rubber in the area of the rubber slit to achieve general field isolation in this specified region selected by the dentist. A barrier material is then applied to the edges of the rubber slit to perfect the final seal of the field isolation. The result is a combination of teeth isolated at the necks of the teeth in the conventional manner, along with the selected teeth with their associated soft tissues exposed for subgingival access.

A common practice by dentists to gain access interproximally (in between the teeth)) when using the rubber dam in the conventional manner, is to stretch the interseptal rubber from between the teeth, then cut it with a scissors to open up access for instrumentation below the neck of the tooth. This allows subgingival access to both the proximal surface of the teeth and also the soft tissues, and thus should be considered a limited approach to general field isolation. One problem with this method is that he the rubber often flexes back in between the teeth and interferes with instrumentation. If the continuous membrane general field isolation dam is employed in this circumstance, a slight bend in the operative perimeter can serve to retract the interseptal rubber and keep it the proximal area open for more extensive instrumentation.

Embodiments of the Invention Applicable to Improvements in Conventional Rubber Dam Isolation Techniques

The conventional rubber dam isolation technique, in which individual holes are punched in order for teeth in an arch to be sequentially drawn through the rubber dam for instrumentation primarily on the clinical crowns of the teeth is a highly effective method of isolating the dentition in order to accomplish routine operative dental procedures and other procedures applicable to this technique. The major problem with the conventional technique of rubber dam application, however, is the attrition rate associated with its use. It is estimated that only 10% use the conventional rubber dam technique regularly in private practice. A larger percentage use it selectively for endodontics in their practices, but limit its use to this area.

The question arises as to why dentists discard this technique and what difficulties do they encounter in the process of applying the dam. The conventional technique of rubber dam usage consists of the clinician punching a series of holes in a rubber dam membrane which correspond to the teeth which the clinician plans on isolating, then pulling the rubber dam membrane over each tooth, sequentially exposing them on the opposite side of the membrane for clinical access for instrumentation. In order to do this, the interseptal rubber must be flossed through all of the contacts of the teeth involved, which is not only tedious to both the dental personnel, but also to the patient. It is, however, the tried-and-true technique of dental site isolation, and has stood the test of time with respect to its efficacy to the dental profession. Retention of the conventionally applied rubber dam has always relied on the use of rubber dam clamps to secure it in place in the mouth. These clamps are generally placed in the most posterior position in the mouth with respect to the dam application, and absorb tensile stresses from the stretching of the rubber membrane over an exterior framework. The clamps are generally made of stainless steel metal, although some plastic and composite clamps have appeared on the market in recent years. They are placed and removed by a rubber dam forceps which is part of the standard armamentarium. Some of the problems associated with the application of the clamps is that they often pinch the gums of the patient, causing discomfort, and easily slide off the tooth if improperly applied or if the tensile forces of the rubber dam are excessive. It is quite possible that the conventional use of rubber dam clamps to secure the rubber dam is responsible for a large part of the objectionable qualities of it as an application. Another shortcoming of the conventional rubber dam technique, is that the polymeric membranes often stretch away from the teeth or tear, causing the clinician frustration and the need to 'start over‘in the process of applying the dam clearly, if some of the problems of applying the rubber dam for conventional use and overcoming some of its shortcomings, the attrition rate of usage might fall.

Embodiments of the Invention as They Modify and Improve Conventional Technique

The invention of modified rubber dam membranes with operative inserts dedicated to improvement of the conventional rubber dam technique which employ the resilient and deformable, or even the rigid inserts, will allow a rubber dam membrane to be retained in the mouth without the use of conventional rubber dam clamps, which often cause discomfort to the patient and fail in their retention of the rubber dam membrane in clinical practice. A series of elastomeric membrane devices with resilient inserts will retain the rubber dam membrane in the mouth by the use of reciprocal forces applied to the patient's teeth and oral structures by nature of flexure of the insert. The resilient operative insert serves two purposes with respect to improving the performance of the conventional rubber dam: first, it serves as a retention mechanism, replacing the need for the application of rubber dam clamps to retain it, and second, the resilient insert serves as a gentle mouth prop which coaxes the patient into maintaining an open mouth during a clinical procedure. A rubber dam device which obviates the need for rubber dam clamps which pinch the patient's gums, causing discomfort, and often fail during treatment procedures, will provide a definite improvement in the art of the conventional rubber dam application. Conventional rubber dam membranes with a resilient operative insert may be applicable for anterior or posterior isolation or whole arch or partial arch isolation. They may be fabricated as flat membranes or three-dimensional membranes with a cut-out intra-alveolar diaphragm; they may be stretched over an external frame which is a Separate device, or they may be fabricated with an integral externally applied framework. They may be the full membranes, or they may be the more abbreviated intraoral rubber dam devices. They may have integrally applied chemically activated, pressure sensitive, or light activated adhesives to aid in retention, or may be a membranes without adhesives. All manifestations of the general field isolation rubber dam membranes previously discussed may be applicable to this type of conventional rubber dam improvement.

Another embodiment of this invention as it applies to improvements to conventional technique is the manufacture of rubber dam membranes with either the elastic or malleable operative inserts around the periphery of the proposed operative site to be isolated. Often the high tensile forces of the stretched rubber dam membrane causes stretching of the rubber around the ‘necks’ of the teeth, either causing open gaps or even tearing of the membrane. Improved rubber dam membranes with inserts which disburse or distribute the tensile forces of the stretched rubber dam, will improve these issues of leakage around the tissue-dam interface and also tearing of the rubber dam membrane during clinical procedures.

Isolation of The Distal Extension Edentulous Ridge or Distally Located Grossly Carious Teeth With Extensive Loss of Coronal Tooth Structure

Some of the most challenging circumstances to isolate with the rubber dam are teeth that are so badly decayed that they have lost most or all coronal tooth structure and that the application of a conventional rubber dam clamp is impossible. Without an anchor to hold the rubber dam in place at the point where flexure is maximal and tensile stresses are at a maximum, application of the conventional rubber dam technique is impossible. No only is clamping impossible, but a conventional rubber dam technique would fail because there is little tooth structure for the dam to be stretched over.

The general field approach to isolating teeth with this extensive involvement is undoubtedly the best approach. A specially designed dam for this type of isolation overcomes the problems associated with not being able to clamp a tooth. It should be noted that a conventional rubber dam clamp has two distinct functions: First, it retains the dam in place, and second, it retracts the rubber dam vertically from the occlusal plane so that the operator will have access to instrumentation as far distally as the clamped tooth. A solution to the inability to clamp a tooth must take into account both functions of the clamp in order to innovatively replace its function.

The distal extension general field isolation dam has an extended metal insert which provides three functions. First, it has an anterior section which is the intended operative perimeter in which the teeth to be instrumented are encircled. This section has a central opening in the dam to allow it to be drawn over the edentulous ridge or to draw it over the grossly decayed teeth to be isolated. Second, it has an extension of the metal insert which is to provide retraction vertically from the occlusal plane of the arch being isolated. By bending the extension in an open “U” shape or a rounded “V” shape, the rubber dam is retracted vertically off the occlusal plane for access to the site to be isolated. The posterior wire extension does not have a central opening and is an integral part of the membrane barrier of the dam. This posterior wire extension follows the direction of the rubber dam externally as it precedes in a direction out of the open mouth toward the external framework where it is stretched and retained by the framework. When properly in place, the central opening provides for the teeth and tissues to protrude into the work site by the anterior ⅔ rd of the insert, while the wire insert extensions of the distal ⅓ rd retract the dam from the operative site.

Since the distal extension isolation dam cannot be anchored in the posterior section with a rubber dam clamp, it must be supplemented with other forms of retention in order to be a filly stable operative perimeter for instrumentation during a procedure. The method of attachment of the anterior portion of the rubber darn is very important to lending stability to the dam in the most posterior area of the arch. The dam in this area should not be attached with a rubber dam clamp, but with a self curing or light curing polymeric putty. This material is necessary to flow into all undercuts of embrasures of teeth in the anterior area to rigidly link the operative perimeter to the teeth in this area. With a sturdy anterior link, the rigidity of the wire or stamping insert lends stability of the operative perimeter in the posterior area of the isolated area. Please note that the operative perimeter in the posterior area should not cantilever over the tissues to be isolated, but must be in intimate contact with these tissues for support of the dam in this area. The distal extension rubber dam may have an enhanced adhesive barrier material integrally applied, which will retain the dam in this area. Another alternative configuration of this dam might lack an integrally applied adhesive barrier material, but a barrier material may be manually applied around the entire periphery of the operative site both to link the dam to the soft tissues and to perfect the moisture seal around the operative perimeter. With all forms of retention applied competently, the dental operator will have a formidable means of isolating this most difficult clinical circumstance.

The specialized design of the general field isolation dam will allow general dentists and endodontists to instrument irrigate root canals properly in this difficult circumstance; it will allow dentists to evacuate decay, place pins and posts, complete base-ups, and prepare prostheses. The design will also apply to distal extension edentuous arches requiring the placement of implants and the subsequent implant prosthetic procedures for the construction of implant-supported prostheses. In any difficult to isolate distal extension procedure, Securing the dam with a retention putty applied over enough teeth to firmly anchor the dam anteriorly is of paramount importance in securing the dam for stability in the posterior area. An adhesive bond in the posterior area alone is not enough to retain the dam in a completely stable position in the application. In addition, for the operative perimeter to protect the dentist and patient from the swallowing or aspirating of foreign objects, the dentists must be ever vigilant that the tissue-dam interface is leak-proof and intact, before using any of the small components that are required to complete these types of procedures. With meticulous attention to competent barrier application, the possibility of a patient swallowing or aspirating a component, instrument, or device or of fluids or saliva leaking through the tissue-dam interface is minimized. In addition to the correct application of the dam described above, it is always important to remind the clinician that any small hand instruments or components that can be ligated before use should be ligated before use as an additional second line of safety precaution before use.

Field Assembly of a General Field Isolation Rubber Dam Using Operative Perimeter Inserts With Conventional Rubber Dam Material

A commercially feasible alternative embodiment is the manufacture of individual rubber or flexible plastic inserts with an embedded textile or synthetic mesh and a wire loop but without the thin flexible rubber dam membrane. This preformed quadrant insert would be molded by the practitioner until it fit the anatomical contours of the operative site, then held in place with a rubber dam clamp while the liquid or putty barrier material bits applied. After polymerization or setting of the barrier material, a specially punched but standard rubber dam membrane is stretched over the entire length of the insert until it snaps into place, sealing the work site. The outer edges of the rubber dam membrane are then stretched over an external framework to control the sheet of elastic and to complete the set-up of the rubber dam for a good operative site during treatment of the patient.

Posterior Buccal and Lingual Bows

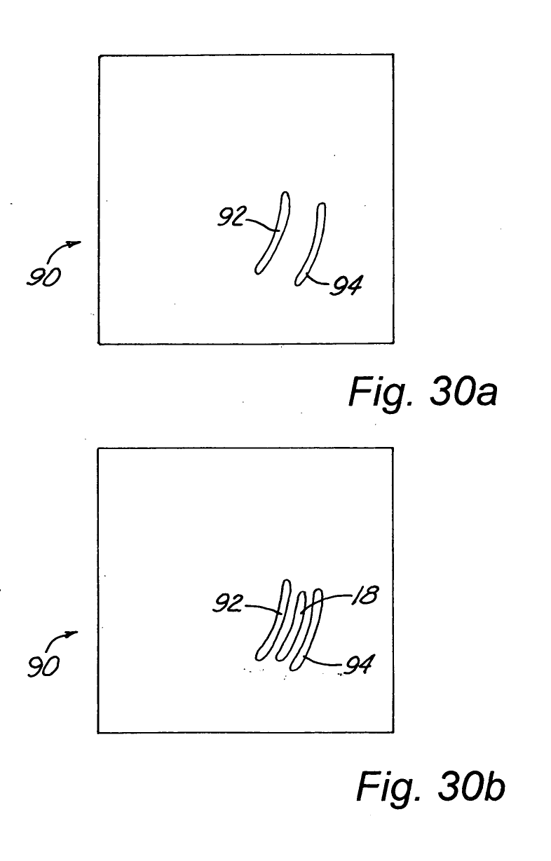

A clinician favoring the hybrid technique in posterior quadrant areas for procedures which are not extensive, such as the preparation of abutments for a Maryland Bridge, or for the seating of a crown or bridge, or for the preparation or seating of bonded units such as onlays, 3/4 crowns, or other prosthetic appliances, may favor a dam 90 with parallel discontinuous malleable elements 92 and 94, such as those illustrated in FIGS. 30a and 30b. In this case, individual holes are punched for teeth in the segment or quadrant to be isolated; then a slit is punched in a localized area where a field isolation technique is to be employed. The malleable elements 92 and 94 may be deformed cervially in order to retract the rubber dam in those areas of the dam dedicated to field isolation. This technique may or may not be augmented with an integral adhesive applied to the tissue side of the dam, or a dam may be selected without an adhesive In most cases, dams used without a central opening (FIG. 30a) for the hybrid technique will not be fabricated with an integral barrier adhesive to control moisture. It is important to note that the clinician may apply a manual paste or gel or putty barrier adhesive to complete moisture control if desired. In other circumstances, it may be desired to provide the dam 90 with a pre-formed central opening 18 (FIG. 30b).

Posterior Isolation for Bonding Procedures

A dam with parallel discontinuous elements may be applied in circumstances where a central opening is present, but extensive cervical retraction of the dam is not required. Such a case might arise when routine operative dental procedures are planned, with preparations which extend subgingivally in interproximal areas. Sometimes preparation of the cervical wall extends so far cervically, that clinicians routinely stretch the dam and cut the interseptal rubber membrane of the dam in an attempt to gain access to these areas. If a quadrant of preparations is anticipated to need this type of access before the clinician starts the procedure, an appropriate choice of dam for these circumstances is a dam with a central opening and malleable discontinuous elements.

General Field Isolation Rubber Dams With Integrally Applied Barrier Adhesives Pressure Sensitive Adhesives:

General field rubber dams may be constructed with barrier adhesives pre-applied in their manufacture. One classification of adhesives of potential application to the general field isolation rubber dam method of isolating tissues are generally are known as pressure-sensitive adhesives, also referred to as PSA's. Pressure sensitive adhesives are viscoelastic materials which, in solvent-free form, remain permanently tacky and will adhere instantaneously to a wide variety of solid surfaces as a result of application of very slight pressure. A PSA is usually applied in the form of a solvent-free coating on a “backing”, often a flexible backing—in this application to the polymeric surface of the general field isolation rubber dam. The PSA attaches the “backing” material (i.e., the flange of the dam), to a “receptor” (i.e., the surface to which the PSA is to adhere to with the application of pressure to the intra-oral mucosa or enamel of the teeth).

The PSA must have characteristics which satisfy the requirements of the application intended-in this case of an intra-oral isolation device. First, it must adhere to the receptor, in this case the hard tissues of the teeth and also the gingival and mucosal tissues, with sufficient t peel strength′ which resists removal from the receptor for the purpose intended. Second, it must adhere to mucosal tissues in the presence of oral fluids being present upon application and continue to adhere tenaciously in spite of being in an environment which is bathed in oral fluids and water during the attachment phase. Third, it must be able to be removed cleanly from the receptor without leaving a residue of adhesive and without causing undue discomfort, tissue damage, or without rupturing the backing material. Fourth, it must be hypo-allergenic or not irritate the mucosal epithelium upon application or in any manner after application.

It is important that the adhesion to the oral tissues is low enough to allow the strip of material to be easily removed by simply peeling off the strip of material using only finger pressure when the dam is removed at the completion of the treatment session. The peel force required to remove the strip of material, which will typically be about ½ cm in width from the oral surface is from about 10 grams to 15 grams per side of oval operative perimeter. Since the removal of the oval perimeter requires both sides to be removed at the same time, this range varies from 20 grams to 30 grams as the dam is stripped off. A wider range of 0 grams to 50 grams is possible due to inconsistencies in the application of the dam and the flexural stiffness of the wire insert within the dam.

There are a variety of compositions of mucosal adhesives that would be suitable as integrally pre-applied barrier substances. Suitable limited water solubility polymer adhesives include: hydroxy ethyl or propyl cellulose. In addition polymer adhesives lacking water solubility include: ethyl cellulose and polyox resins. Other possible adhesives suitable for integral application is polyvinylpyrrolidone; or still another is a composition of Gantrex and the semisynthetic, water-soluble polymer carboxymethyl cellulose. The widely used cyanoacrylates; methyl, dimethyl, ethyl, butyl, octyl and other are compositions compatible with mucosal tissue adherence. These PSA's can comprise a base polymer alone or a mixture of base polymer and one or more additives such as plasticizers, tackifiers, fillers, stabilizers, and pigments. This list of PSA's does not exhaust the range of possibilities of alternatives for integrally applied adhesives, and should not serve to limit the options available for this application. Further descriptions of PSAs compatible to this application may be found in The Encyclopedia of Polymer Science and Engineering, (New York, John Wiley & Son, 1988;) or the Handbook of Pressure-Sensitive Adhesive Technology, Ed. Don Satas (New York, Van Nostrand Reinhold Co., Inc. 1982) or A. H. Flanagan, Adhesives Technology Handbook (Park Ridge, N.J., Noyes Publications, 1985), or many other Journals or publications of polymer science.

The integrally applied adhesive substance may be in the form of a viscous liquid, paste, gel, solution, or other suitable physical form in a substantially uniform continuous coating around the inner peripheral latex flange of the operative work site, on the side of the rubber dam designated for direct contact with the hard and soft tissues of the operative site. The adhesive is covered by an easily removable covering, called a release liner, which keeps the adhesive in a maximally tacky state until it is required for use. At this time, the release liner is stripped off, exposing the adhesive, and applied to the receptor.

The release liner may be composed of a single piece of flexible or rigid material or from two overlaying pieces of said material such as a typical adhesive strip bandage design. The release liner is preferably comprised of any material which exhibits less affinity for the adhesive coating than the adhesive substance exhibits for itself, and strips off with finger pressure to expose the adhesive film that it is adhered to. This liner may be comprised of a rigid sheet of material such as polyethylene, paper, polyester, or other material which is coated with a non-stick type of material. The release liner material may be coated with Teflon®, wax, silicone, fluoropolymers, or other non-sticky coating.

General Field Isolation Rubber Dams with Integrally Pre-applied Pressure Sensitive Adhesives Acting Primarily as Barrier Materials (Primarily Non-Retentive)

General field isolation rubber dams with pre-applied mucosal tissue adhesives acting as barrier agents to refine the integrity of the moisture seal between the patient's oral cavity and the dentist's operative work site will save time and effort for the clinician when applying the rubber dam for use in a procedure.

In the case of PSAs used primarily as barrier materials the general tackiness and retentive adherence of the flange of the dam by the adhesive need not be strong enough to retain the rubber dam in place, since mechanical forces of applied rubber dam clamps and the rigidity of the wire insert are the principal means of retention of the dam. The applied adhesive need only attach the flange of the rubber dam to the hard and soft tissues with enough retentive force to prevent breakage of the moisture seal by frictional forces created by the lips, teeth, tongue, and other extraneous forces applied during a typical treatment session.

General Field Isolation Rubber Dams With -Integrally Applied Adhesives Acting as a Significant Retentive Force for the Dam While also Acting as a Barrier Material

General field isolation dams which are fabricated of latex, neoprene, or other polymeric materials in the range of thin, i.e., (0.008 cm) to medium (0.010 cm) ranges, or made of highly flexible alternative polymeric materials which generate low internal tensile forces when flexed, or coated with integrally pre-applied (or manually applied by the end-user) adhesive barrier materials with superior adherence to mucosal tissues, or used in circumstances where the stretching of the dam is minimal (i.e., isolation of anterior segments or isolation for biopsy or soft tissue surgery) may be fabricated with attenuated wire or metal stamping inserts or wholly without a wire or other insert and achieve a comparable result. Construction of a general field isolation dam of this type requires an enhanced thickness of polymer material around the operative perimeter, and either has an attenuated metal or other insert or does not have a wire, metal stamping, or other material inserted into the dam. Generally, a thickness of pressure sensitive adhesive (PSA) is applied to the thickened flange bordering the central opening of the operative perimeter on the side of the membrane which is to come into contact with the mucosal tissues. This thickness of material acts to prevent the dam from tearing in the area of the operative work site, and also disperses tensile forces of the flexed membrane from forming a focal spot which could tear the dam or create an adhesive failure. The increased thickness of the operative perimeter creates a definitive border for the work site which may be easily flexed or molded to the anatomic contours in an analogous way to dams with the inserts present. While the dam lacks the memory function of the insert, the spongy material of the dam exerts only a minimal rebound effect upon flexure (i.e., spongy materials such as polymer rubber has low values of modulus of elasticity; E=0.10(10 ksi or 0.70 MPa) which is easily overcome by the strength of the PSA to the receptor.

In this application, the integrally applied barrier adhesive acts more directly as a contributing form of retention of the dam as well as the barrier seal to refine the flow of moisture between the dentist's work site and the patient's oral cavity. Retention of the dam in this case is not wholly the action of the PSA adhesive, but is supplemented by the application of rubber dam clamps at locations of maximal tensile forces due to stretching of the polymeric material. Other alternative forms of supplemental retention for the general field isolation rubber dam with an attenuated or absent insert are polymers or substances applied to the dam and to the teeth simultaneously to lock the dam mechanically to undercuts and embrasures of the teeth, (i.e., simple rubber base putty, or various brands of vinyl polysiloxane putty currently marketed as impression materials or polyether, silicone, or other impression materials used with their appropriate adhesives to link them to the dam), or still other options are the more expensive barrier formulations with adhesive characteristics already included in their formulations. Still other methods of retention include the use of wooden wedges applied to anchor the dam, or suturing of surgical dams, or rubber dam embrasure clips as described in detail in this patent as associated retainer apparatus for the general field isolation rubber dam.

Non-Pressure Sensitive Adhesives

Other classifications of tissue adhesives are polymeric compositions which are designed to adhere to hard and/or soft tissues of the human body (fibrin glues an methacrylates are two commonly applied categories, but other compositions may also be substituted), but need an initiator to activate the process of polymerization and adherence to the receptor, which is the tissue surface of the intended application. Generally, initiators fall into three categories of chemical, thermal, and photopolymerization. Tissue adhesives which are chemically activated may be initiated with chemicals applied to them or chemicals naturally present in the biological tissues of the application. Water is one chemical which may be applied directly to a tissue adhesive by the clinician or may be found naturally in saliva. Hence, there are biologically compatible tissues that may be selectively activated by water. Other tissues adhesives may be activated by the application of or contact with other chemicals, such as components of human saliva or even proteins present in on the epithelial surface of the gingiva or mucosal tissues in the oral cavity or by proteins present in the enamel pellicle coating the surfaces of the teeth. Still other tissue adhesives are designed to be photoactivated by the exposure to light of a certain intensity and wavelength. Tissue adhesives activated by any of these methods are candidates for integral application to the general field isolation rubber dam.

General Field Isolation Rubber Dams with Integrally Applied Photoactivated Tissue Adhesives

General field isolation dams with integrally applied tissue adhesives requiring photoactivation for adherence to hard or soft tissues of the oral cavity or other extraoral tissues will be of great efficacy to the clinician in establishing adherence of the tissue-dam interface as a barrier to refine the moisture seal of the application or as retention of the dam to the tissues to be isolated or combination applications of barrier/retention simultaneously. General field isolation dams may be constructed to enhance the translucence of the polymeric membrane so that a photoactivated tissue adhesive which is applied to its surface may be activated by shining a visible wavelength curing light through the dam in order initiate polymerization and adhere the dam to the tissue surface. The ideal photoactivated tissue adhesive for this application would have a non-tacky dry, adhesively inactive external surface and would adhere to the dam tenaciously during the molding of the operative perimeter to the anatomical structures by the clinician in the preparation stage. Once in place and in contact with the tissues to be isolated, a visible wavelength light curing unit would be activated to shine light through the dam, turning the tissue adhesive into a gel with a wetting ability to make it intimately compliant to the surface, which means that it conform three dimensionally to the surface during polymerization to create a competent adhesive-tissue interface, which, after polymerization is intact, adheres the adhesive and the dam tenaciously to the surface. (Note: the degree of tenacity of retention of the adhesive-tissue interface is discussed under the pressure-sensitive adhesives discussion of peel strength and is the same requirement in both types of bonding of adhesives.) The same requirements of the adhesives applied in this type of application, such as being suitable in a moist environment and insoluble to moisture in saliva and other water-based liquids applied during a procedure, as indicated in the discussion of pressure-sensitive adhesives is applicable to the application of these adhesives also.

General Field Isolation Rubber Dams with Both Resilient and Deformable Operative Perimeter Inserts for Specialized Isolation Requirements Requiring Reciprocal Arch Retention for Stability

In some cases, general field isolation rubber dams will require an operative insert with both qualities of resiliency and deformability in order to satisfy the requirements for ease of application, retention, and stability for a given application. Our previous discussion of operative perimeter inserts focused on perimeter inserts which were designed for intra-arch applications (those applied wholly within a given single arch), requiring inserts which were highly malleable and moldable and would adapt with finger pressure to the slightest nuance of intent on the operator's part of conforming to any anatomical form. These inserts generally had a very low yield point, no resilience upon plastic deformation making them a memory device to record the operator's anatomical adaptation requirements, and were untempered with only slight or no heat-treatment if they were composed of a metal. These continuous loop inserts were described as requiring handling characteristics for bending under prescribed experimental conditions which were acceptable between a range of zero and six pounds of bending pressure, with preferrably ideal or near-ideal values of 1.5 lbs. to 2.50 lbs. of bending pressure if retained without the contribution of mucosal adhesives and lower values if an adhesive retentive mechanism was to be used.

The general field isolation rubber dams with operative inserts with simultaneously utilizable qualities of resiliency and deformability will apply to specialized field isolation rubber dams designed primarily for inter-arch applications (those applied simultaneously between two opposing arches or two opposing quadrants or segments of teeth.) In this case, the operative insert must satisfy the quality of being deformable either by finger pressure or by the use of specialized bending pliers while also satisfying the requirement of flexure from a pre-determined configuration in order to generate a reciprocal force which is applied to each opposing arch, segment, or quadrant of teeth to be isolated. The resultant flexed operative perimeter, when applied in such a circumstance, imparts the qualities of being a retentive device to be generally supplemented by the use of standard rubber dam clamps, or retained with the concurrent use of mucosal adhesives, or in some circumstances as a retentive mechanism in and of itself. It also functions as a mouth prop to keep mouth open during a dental procedure by retraction of the mandible, and a stabilizing device to retain the operative perimeter in intimate contact with the gingival and mucosal tissues in specialized applications requiring the use of reciprocal inter-arch force.

Description of an operative insert which fulfills these requirements is best described in relation to a metal specifically chosen and tempered to specifications for the application. Tempering of the metal locks in a memory of the configuration of the insert at the time of firing. An operative insert may be wholly within a flat plane at the time of firing or may be fired in a three-dimensional configuration. Whatever the configuration at the time of firing, a memory of that configuration is locked into place by crystallization of the matrix of the metal. Flexure of the insert within the elastic limit up to (but not including) the yield point of the resultant tempered metal will bias the insert toward returning to its predetermined configuration without resulting in any permanent deformation. Generation of reciprocal forces within this range to return the insert to its original pre-set configuration are best described by the modulus of elasticity and the flexural modulus. The qualities imparted to the operative insert satisfying these specifications are retention of the insert, ease of application, and retraction of the mandible to prop the mouth open, and 4. stabilization of the operative insert. The second handling characteristic of a resilient operative insert is the requirement of deformability of the insert to adapt to the anatomical contours and configuration of the clinical application. Due to the fact that this operative insert is tempered for resiliency, the yield point for permanent deformation to occur will be higher than the yield point for the malleable non-resilient insert. This means that the end user will have to apply more bending pressure to conform the operative insert to his requirements for his application. This may be accomplished by using a higher amount of finger pressure or by the use of othodontic or specialized bending pliers. In any case, moldability will be compromised for this type of insert, but the diminished ability to adapt the operative perimeter will be compensated for by the introduction of the new handling characteristics which will satisfy requirements of specialized applications with alternative designs of general field isolation rubber dams.

Operative inserts imparting both deformability and resiliency may be constructed out of wire, metal stampings, die cast parts, or other formed parts if the material used is a metal; or molded or otherwise formed parts if the material is simultaneously a resilient but also a deformable plastic, polymer, composite or other substituted material. In addition, a substitute could be any device that would fulfill the material handling qualities required for this type of application.

The applications which this type of rubber dam device would apply to will require specialized designs of an interarch operative insert which utilizes the reciprocal forces of both the maxillary and mandibular alveolar arches interrelating with the flexure of the muscles of mastication. These rubber dams may be manufactured in a flat plane configuration, requiring the operative insert to be flexed from a 180 degree configuration to approximately a 30 to 40 degree angle to be inserted into the open mouth during application. Another configuration for manufacture would be for the operative insert to be tempered in a rounded “V.” or an open “U” shape with an angular opening of roughly 45 to 65 degrees, requiring less flexure and therefore less reciprocal tension being applied to the muscles of mastication during treatment.

General field isolation rubber dams with resilient and deformable inserts which are designed for single or dual opposing quadrant use on only one side of the mouth would be quite useful for fast insertion in emergency circumstances, or for isolating the completely edentulous distal extension alveolar arch without the use of rubber dam clamps, or for isolating an arch of teeth which is comprised of grossly carious teeth in the back of the arch which do not lend themselves to the application of rubber dam clamps, or for various other applications requiring fast isolation of an arch or arches or applications which are quite difficult to isolate with the malleable distal extension rubber dam or other techniques.

General field isolation rubber dams with resilient and deformable operative inserts which are designed for whole arch isolation will be quite useful in orthodontic applications either with the application of rubber dam clamps or without the use of such clamps. These whole-arch general field isolation rubber dams may be designed and manufactured in either an open 180 degree flat form for full flexure or in a 45 to 65 degree rounded “V” or open “U” configuration for the generation of less reciprocal force during an application. The degree of forces applied during flexure from either a 180 degree or a 45-65 degree angle can also be modified by variables of the composition of the operative insert, including type of metals and alloys of metals or plastic, composite, polymeric materials chosen for its composition, cross-sectional configuration, amount of material in cross section, degree of tempering, or other factors contributing to the modulus of flexure of the operative insert. The rounded “V” or open “U” shaped full arch general field isolation rubber dam with either the soft moldable insert or the resilient and deformable insert may be manufactured on a generally rounded “V” shaped or open “U” shaped die for dip molding or a similarly designed cavitation in a mold if injection molding is the process to be used for manufacture. This 45 to 65 degree dam may be designed with a generally concave configuration lingually to the operative inserts for an increased accommodation to the patient's tongue and oral cavity for comfort during the application during treatment. This specialized design for a reciprocating full arch general field isolation rubber dam could isolate a single arch at a time or the two opposing arches at once, could be applied with or without the use of rubber dam clamps, and would be stretched over a separate rubber dam frame or would be designed with an integral external rubber dam frame. A closely related isolation device which would not be stretched over an external frame and therefore not be considered a true rubber dam in the vernacular of the prior-art usage of the term would be possible to design, but would have less utility to the dentist unless supplemented with a separate device to reciprocally retract the patient's lips (such devices are available commercially). This device would attempt to duplicate the overall outcome of the specially designed general field isolation rubber dam described above, but would instead be classified as an intra-oral barrier or isolation device. This possible alternative design should be considered an extension of this overall general field isolation design and therefore should be considered an alternative embodiment described within the spirit and scope of this patent disclosure.

General field isolation rubber dams with resilient operative inserts are generally stretched over a framework external to the mouth in the same manner as any other true prior-art rubber dam or previously described general field isolation rubber dams. The external framework may either be a separate frame device such as a standard Young's Frame currently in use in most dental offices in the U.S. or internationally, or any of the standard variations of frames known in the prior art, or could be the improved general field isolation rubber dam frame described in this patent application. As an alternative, the external framework might be integrally attached to the periphery of the rubber dam membrane and located integrally within the surrounding frame a rigid or moldable or flexible wire, stamping, die-cast part or plastic, elastomeric, or composite material embedded within the framework to impart whatever qualities are desired in a an external framework.

The true prior-art rubber dam in dentistry is composed of an elastic membrane generally 6″×6″ square of varying thicknesses for adults or a 5″×5″ square elastic membrane for pediatric applications. The prior-art rubber dam is generally stretched over an external rubber dam frame device which engages the rubber dam membrane by stretching the membrane over ‘nibs’ to attach it the framework. Reciprocal forces applied by the stretched membrane to the framework hold it in place and retract the lips, creating increased access to the oral cavity. This is largely a circumferential type of retraction in all directions. There are a number of products emerging in the contemporary marketplace which purport to be rubber dams with integrally attached frames. Some have integral frameworks located wholly outside of the mouth which are attached to a rubber dam membrane roughly paralleling the function of a true rubber dam/rubber dam framework assembly and should be rightfully called an extension of the true rubber dam prior art. Others have integral frameworks which are not external to the oral cavity as defined by the vermilion border of the lips and/or do not completely retract the lips in a 360 degree manner as in the true prior art, and therefore should not be defined as true rubber dams in the prior art context. Hence, any framework which does not retract the lips from at least the vermilion border of the lips or outwardly in a radial direction from this location and/or retract the lips in a true circumferential manner, should not be considered a rubber dam in the true prior art sense but should be classified as an intra-oral barrier or isolation device.

Abbreviated Intra-oral Field Isolation Rubber Dam Devices

Some clinicians who do not favor the full rubber dam membrane for isolation will benefit from more abbreviated intra-oral field isolation rubber dam devices. These smaller devices will have the same range of attributes of operative inserts that the full field isolation rubber dams will have, but generally will have a smaller or distinctly different external framework. They may be manufactured as flat form rubber dam devices or may be fabricated on three dimensional molds. The devices may have operative inserts and frameworks which are elastic, malleable, resilient and deformable, or rigid, as the given application requires. They may or may not have integrally applied chemically activated or pressure sensitive or photoactivated adhesives applied. They may be used with or without any manually applied barrier adhesive. They may be constructed with operative inserts with malleable or resilient and deformable wires, stampings, die castings, or other manufacturing processes; or they may be fabricated of or memory retaining plastics or composites, or injection molded plastics that act primarily as a static element, with some resiliency in the elastic range, in short, all of the variations of the true rubber dam membranes will be applicable to these classes of device. Some of the intra-oral field isolation rubber dam devices will be used in conjunction with cheek retractors, to compensate for the fact that in some cases they will not have an exterior peripheral membrane which retracts the lips and cheeks. One type of intra-oral field isolation rubber dam device will have an operative insert which integrally merges with a peripheral frame, and vice versa. The whole gamut of general field isolation is possible with intra-oral rubber dam devices as well as the full membrane approach. The alternative preferences of the dental clinician will be fully accommodated by this series of intra-oral rubber dam devices.

Some discussion of intra-oral rubber dam devices is necessary to classify them and to differentiate their form and role from the true prior art of the dental rubber dam. The true prior art rubber dam in dentistry is composed of an elastic membrane generally 6″×6″ of varying thicknesses for adults or a 5″×5″ square elastic membrane for pediatric applications. The prior art rubber dam is generally stretched over an external framework which engages the membrane with “nibs” (small metal projections which catch the stretched rubber) to attach the membrane to the frame. Reciprocal forces applied to the stretched membrane by the framework, hold it in place and retract the lips and cheeks of the patient. This retraction of the lips and cheeks is largely circumferential in nature, occurring in all directions. There are a number of products emerging on the market which purport to be rubber dams with integrally attached frames. Some have integral frames located wholly outside of the mouth which are attached to the rubber dam membrane in roughly the same manner as in the traditional true rubber dam application. These should be considered true rubber dams. Others have integral frames which are not externally applied wholly outside of the patient's mouth, as in the traditional rubber dam application. They do not allow the rubber dam membrane to retract the lips in a complete 360 degree manner as in the true prior art. For the sake of classification, any framework which does not retract the patient's lips in a 360 degree manner as defined by the vermilion border or the interface between the non-keratinized mucosa and the beginning of the keratinized epithelium of the skin, should not be classified as a true rubber dam in the prior art sense, but should be considered either an intra-oral rubber dam device or an intra-oral barrier device. Since these intra-oral devices lack an external membrane to retract the lips, they may be supplemented with a variety of lip retractors commonly known in the prior art.

The Three-Dimensional, Fully Contourable Rubber Dam With a Mesh or Solid Planar Malleable Operative Insert

The three-dimensional, fully contourable rubber dam with a mesh or solid planar malleable insert is an extension of the concept of the insertion of an operative insert, but instead of a wire or a metal stamping located somewhere in the membrane, the insert is either a solid sheet of malleable material or a malleable type of mesh material, interposed between exterior sheets of polymeric material. (Note: if a solid planar sheet or sheet of malleable mesh is substituted without the exterior layers of polymeric material, this alternative embodiment should be considered to be within the scope and spirit of this disclosure). The sheet of malleable material allows the dam to be fully contoured in a similar manner as the action of a foil. This allows the dam to retain the memory of the configuration that the clinician molds it into in order to satisfy his procedural requirements. This dam may be directly die-cut into any of the arch configurations of the other types of rubber dams, or may be designed with operative configurations where the malleable sheet is not present, so that the resilient polymeric rubber dam material may exert a resilient, constrictive action around the operative site. Whatever the configuration chosen for applications in which this field isolation rubber dam is considered beneficial, this unique type of rubber-dam will be another highly useful option in the armamentarium of the clinician.

Polymeric Membrane Specifications

General field isolation dams of the present invention for dental purposes will consist generally of 6″×6″ square polymeric membranes for adults or 5″×5″ square membranes for children, with generally accepted specifications of thicknesses according to accepted dental standards, with the following values: thin 0.006″; medium 0.008″; heavy 0.010″; and extra heavy 0.012″. While these standard values will most likely be found to be the most useful, any general field isolation rubber dam manufactured with the parameters of 0.002″ to 0.200″ should be considered to be within the area of general filed isolation dams of the present invention.

The membranes may be manufactured of a wide variety of polymeric or thermoplastic materials such as latex, neoprene, silicone, polyethylene, vinyl, polyurethane, or other polymeric or thermoplastic materials of suitable qualities, so long as the membranes demonstrate the physical handling characteristics necessary for successful clinical field isolation of the dental operative site. Some of the typical parameters of physical characteristics of materials required of these polymeric membranes are: range of tensile strength 2,500-10,000 psi; elongation at break 400-1,110%; hardness (shore) 60-100A; and notched resistance to tearing 100+kilonewtons per meter. These characteristics of physical materials are general guidelines only. Individual materials may vary depending on their composition and physical attributes, but still be considered to be within the spirit and scope of this invention.

Wire or Insert Selection and Specification

Embedded with the polymeric membrane in an appropriate position is a continuous wire loop, metal stamping, or other suitable material with the requisite material handling characteristics and specifications. The shape of the loop, the cross-sectional shape of the material, the amount of material in cross section, the area moment of inertia, the alloy chosen on the basis of its modulus of elasticity, tensile strength, and yield point, and degree of tempering may vary, as long as the handling characteristics and mechanical properties of the insert requirements are satisfied with relation to the ease of bending by the operator and the resistance to deformation by the type and thickness of the stretched polymeric membrane within which it is inserted or to which it is applied.

While the behavioral characteristics of a metal formed into a wire or metal stamping are described for reference, any alternative material or device substituted should impart the following qualities: The operative perimeter should be quite soft and malleable so as to be easily bendable into any form required by the clinician manipulating it with finger pressure—at the preferred specifications, the clinician should feel that he or she is actually molding the operative perimeter instead of feeling like they are bending a stiff wire or metal stamping; once bent into the configuration required by the anatomical operative site, the wire must maintain its configuration with tenacity of a “memory” of the clinician's specifications and requirements for use without rebounding to another shape; it must withstand the tensile forces applied to it by the elastomeric membrane when it is stretched over an external framework and when subjected to the normal stresses of the restrained musculature during an ongoing procedure, such that it does not appreciably distort from the desired operative shape designated by the clinician who formed it.

Wires of different materials and different gauges were sought out for insertion and the operative inserts of the dam in this disclosure. Initially, wires of different metals and diameters were chosen from an intuitive basis for qualities of easy bending and handling and also resistance to moderate stresses. Through a process of trial and error, for different materials were selected and the appropriate gauges of wire narrowed down to refine the outcome of constructing inserts with appropriate handling characteristics for this disclosure.

A. Dead-soft, malleable inserts.

To test wires that were under consideration, an experiment was designed as follows. The test wire was first bent 180° around a cylindrical object with a 3/16″ diameter to form a U-shape configuration simulating one end of a typical operative insert. The U-shaped wire was inserted into a vise with ¾″ of the rounded loop extended perpendicularly of the vise. A strain gauge with a hook was attached to the end of the loop and pulled until the wire has been bent 45° from its initial position. An annealed copper wire of 0.040″ diameter was tested and found to require between about 1.75 and about 2 lbs. of pressure on the strain gauge. Since this wire had a satisfactory feel when deformed by hand, this range of force was selected as a preferred range. A 20 gauge C1008 brite annealed steel wire was similarly tested and found to have about the same range of force. Testing also revealed that an annealed 0.033″ diameter LVM stainless steel wire required about 1.64 to 2 lbs. of pressure to bend.

A number of diameters of aluminum wire were subjected to the same experiment. Aluminum, a very soft and pliable metal, proved to have excellent qualities of plasticity over a range of different diameters. A 0.050″ wire required 1.25-1.50 lbs. of bending pressure, while a 0.064″ wire of the same alloy required 1.75-2.00 lbs. of pressure, both within excellent ranges. Both larger and smaller diameters would be applicable to polymer membranes of different thicknesses. Larger diameters up to about 0.070″ might fulfill the handling characteristics required, but the diameter of wire would be quite thick for the application. It should be noted that while wire samples were measured for this application, metal stampings, or die-cast parts or other methods of producing the parts which would duplicate the amount of material in cross section would be comparable.

To further refine a range of optimal handling characteristics and to ascertain the parameters of acceptable substitutes for inserts in this particular thickness of latex rubber dam, a series of numbers were used to rate handling characteristics of wire loop inserts for two different metals, aluminum and bare copper wire. A scale of 1 to 10 was used for the rating scale, with 10 representing the most optimal performance of a wire loop insert for the application, and 1 representing an outcome that would be undesirable in any circumstance. The degrees of the scale are listed below for more clarification:

| Rating Number | Handling Characteristics |
|---|---|
| 10 | Excellent High Optimal |
| 9 | Near Optimal |
| 8 | Sub Optimal |
| 7 | Acceptable |
| 6 | Useful in many circumstances |
| 5 | Useful in some circumstances |
| 4 | Useful in few circumstances |
| 3 | Undesirable in many applications |
| 2 | Undesirable in most application |
| 1 | Undesirable in any circumstance |

Aluminum 1100 Wire Loops

| Wire | Diameter | Gauge | Forces | Rating of Handling |
|---|---|---|---|---|
| # | (inches) | (AWG) | (lbs.) | Characteristics |
| 1 | 0.0201 | 24 | 0.05 | 1 |
| 2 | 0.0253 | 22 | 0.12 | 2 |
| 3 | 0.0319 | 20 | 0.25 | 3 |
| 4 | 0.0403 | 18 | 0.5 | 6 |
| 5 | 0.0508 | 16 | 1.50 | 10 |
| 6 | 0.0640 | 14 | 1.75-2.0 | 9 |
| 7 | 0.0808 | 12 | 3.75-4.0 | 3 |
| 8 | 0.1250 | 8 | Way too high | 1 |

Bare Copper Wire Loops

| Wire | Diameter | Gauge | Forces | Rating of Handling |
|---|---|---|---|---|
| # | (inches) | (AWG) | (lbs.) | Characteristics |
| 1 | 0.0200 | 24 | 0.25 | 1 |
| 2 | 0.0250 | 22 | 0.5 | 2 |
| 3 | 0.0320 | 20 | 1.0-1.25 | 7 |
| 4 | 0.0400 | 18 | 1.75-2.0 | 10 |
| 5 | 0.0510 | 16 | 2.25-2.50 | 8 |
| 6 | 0.0640 | 14 | 5.50-6.0 | 2 |
| 7 | 0.0800 | 12 | 7.0-8.0 | 1 |

In summary, the material required in this application needs to be in an annealed state or at the most or have a soft temper, if it is a metal. According to the experiments conducted, wire loops of varying material alloys and varying diameters of cross section, bent with a force of from 1 & ½ lbs. to an upper limit of 2 & ½ lbs. were considered optimal with regard to handling characteristics by the operator and were within an acceptable range of resistance to deformation by tensile forces of the stretched medium thickness (0.008″) latex membrane. While other wires of varying diameters and gauges were tried for this application, many of which might be substituted and achieve somewhat acceptable results, the four wire/diameter combinations were chosen because they approached a range of optimal performance. Wire inserts with a bending force as measured by the aforementioned means with a range of from 2 & ½ lbs. to 4 lbs. of bending pressure were also possible candidates for construction of a general field isolation dam, but between 4 lbs. −6 lbs. of force as measured by the strain gauge demarked a gradual deterioration of the proper handling characteristics for the application, making the construction of a general field isolation d dam in this range or above gradually more undesirable but still possible from a clinical standpoint. Any use of an insert above 6 lbs. of bending pressure would be unacceptable in any malleable operative insert designed for manipulation with finger pressure alone.

While wires were used in the initial production of prototypes to ascertain the optimal handling characteristics and the parameters of performance of the operative inserts for the general field isolation rubber dams, it should be noted that the values obtained may be extrapolated to substitutes for the construction of inserts such as metal stampings or die cast parts or other formed parts if the insert is a metal, or molded parts is the material is a memory-retaining plastic or composite or other material to be substituted. It is also possible that larger diameter wires or stampings, with grooves cut in the material with a high enough density could weaken the material enough to simulate a similar result. Any other material or device that would serve as a substitute, however, must fulfill the clinical material handling characteristics as specified by this experimentally derived criterion for this application.

General field isolation rubber dams with integrally applied pressure sensitive adhesives, whether intended solely for the purpose of forming a seal at the mucosal-dam interface as a barrier material to prevent moisture leakage, or as a combination application of barrier material to prevent leakage of the dam and also as a form of retention, or as the principal form of retention of the darn, will affect the diameter of the wire required or the amount of material required in the case of substitute. In this situation, the amount of tensile strength of required resistance by the wire, is inversely proportional to the amount of retention supplied directly by the adhesive. In other words, a smaller diameter wire is required as the adherence of the adhesive to the mucosal interface increases. Indeed, with superior mucosal adhesives and thin, highly elastic polymeric materials, elimination of the wire or insert altogether is possible (See general field isolation dams with integrally applied adhesive barrier materials, without a wire or metal insert).

B. Reciprocal Forces in Resilient and Deformable Inserts

To test the characteristics of both resilient and deformable operative inserts the optimal characteristics of resiliency and the generation of reciprocal forces, and to determine parameters within which these resilient inserts might function successfully, the following experimental protocol was devised:

Resilient operative inserts designed for insertion into general field isolation rubber dams to isolate a quadrant of teeth on one side of the mouth were inserted and secured in a vise in the following manner: one end of the insert was inserted 0.750″ into the vice and at a right angle to the face of the vise and secured. The length of the operative inserts tested were all uniformly 4.000″ inches long and 0.750″ wide. They were substantially flat and biased by tempering to remain in a flat configuration. Once secured in the vice, the resilient operative insert was flexed 180 degrees and secured at the free end to a digital measurement strain gauge to measure the amount of reciprocal force generated by flexure to 180 degrees. The testing was repeated on a series of operative inserts until test results showed a consistent pattern of repeatable results. The testing measurements from the experiment were as follows:

In the second phase of ascertaining a range of optimal handling characteristics of clinically useful resilient and deformable operative inserts and to ascertain parameters of acceptable resilient operative inserts for different applications, the experimental values of reciprocal forces which were recorded for the experimental inserts were correlated with clinical trials in which patients judged the handling characteristics of general field isolation rubber dams with resilient operative inserts of varying reciprocal forces by assessing the following criteria:
a. Comfort to the patient upon insertion and removal
b. Fatigue of muscles of mastication causing discomfort over time
c. Adequacy of aiding the patient in maintaining an open mouth

In addition, the experimental inserts were correlated in clinical trials in which dentists judged handling characteristics of general field isolation rubber dams with resilient operative inserts varying reciprocal forces by assessing the following criteria:
a. Base of insertion and removal into the oral cavity
b. The dentist's perception of comfort to the patients
c. Adequacy of maintaining the mouth in an open position
d. Adequacy of maintaining the GFI rubber dam in position

The results of determining handling characteristics from both patients and dentists were correlated and the GFI rubber dam inserts rated according to the same rating scale used to evaluate the handling characteristics of the malleable operative inserts. That rating scale was a 1 to 10 scale with 10 representing the most optimal performance of an insert and 1 representing an hat would be undesirable in any circumstance. The degrees of the scale are listed below again for reference:

| Rating Number | Handling Characteristics |
|---|---|
| 10 | Excellent High Optimal |
| 9 | Near Optimal |
| 8 | Sub Optimal |
| 7 | Acceptable |
| 6 | Useful in many circumstances |
| 5 | Useful in some circumstances |
| 4 | Useful in few circumstances |
| 3 | Undesirable in many applications |
| 2 | Undesirable in most applications |
| 1 | Undesirable in any circumstance |

Resilient and Deformable Wire Loops

| | Values of | Rating of | |
|---|---|---|---|
| Wire | Reciprocal Forces | Handling | |
| # | (lbs.) | Characteristics | Characteristics |
| 1 | 0.00 | 4 | Malleable/no forces applied |
| 2 | 0.04 | 7 | Acceptable |
| 3 | 0.08 | 10 | Excellent high optimal |
| 4 | 0.12 | 10 | Excellent high optimal |
| 5 | 0.16 | 8 | Sub optimal |
| 6 | 0.20 | 6 | Useful in short applications |
| 7 | 0.24 | 5 | Useful in short applications |
| 8 | 0.28 | 4 | Useful in short applications |
| 9 | 0.32 | 4 | Useful in short applications |
| 10 | 0.3 | 4 | Useful in short applications |
| 11 | 0.40 | 3 | Short emergency applications |
| 12 | 0.44 | 3 | Short emergency applications |

It should be noted that general field isolation rubber dams with resilient and deformable inserts which generate different reciprocal forces may be useful in different clinical circumstances. Many dental appointments are approximately one hour in length, but this is not universally true. Short emergency appointments of approximately ½ hour are common, as well as extended 1 and ½ hour to two hour appointments for extensive reconstruction are possible. If a resilient insert exerts too much pressure over an extended period of time, muscular fatigue and cramping will occur, causing the patient discomfort. On the other hand, if a burly patient has a very strong musculature, an insert which generates a higher amount of reciprocal force is necessary to encourage the patient to keep his mouth open during the procedure. A patient going through orthodontics at an age of 14 to 16 will not be able to resist the reciprocal forces of a resilient insert that is appropriate for an adult patient going through the same treatment regimen for this reason, general field isolation rubber dams with different values of reciprocal forces are appropriate in different circumstances.

The forces required to bend and permanently deform a resilient operative insert will naturally be higher than the bending of a highly malleable insert, due to the tempering of the metal insert to produce a memory characteristic. Heat treatment of a metal increases the hardness of a metal, raising its yield point and the range of its elastic limit. For this reason, the forces that were calculated for bending a malleable insert are not applicable to this type of application, all values for bending these inserts are shifted upward from the experimentally determined values for the malleable inserts. The upper limit of using finger pressure to bend these inserts may give way to routine bending with an orthodontic pliers or other bending pliers to form the transverse arches and labial and lingual bows.

The inventor recognizes that sometimes the fabrication of any device or product undergoes modification in the process of conforming to practical necessities of existing manufacturing processes, or succumbs to the economic practicalities of producing a product which has an acceptable margin of cost of production to final cost to the end user. For this reason, a number of modifications of embodiment subject to technical and economic pressures associated with the final fabrication of marketable devices is discussed. All changes of embodiment associated with these practicalities should be considered as falling within the parameters of the spirit and scope of this disclosure.

The highest level of embodiment of both the general field isolation and conventional isolation operative inserts is the continuous loop of like material, which may be molded into its functional configurational elements of anterior and posterior transverse arches, labial bow, and lingual bow. The term “continuous loop of like material” refers to an insert having the same contiguous malleable material all the way around its circumference. Hence, a reference to an operative insert as being a malleable, or resilient and deformable, or elastic, or rigid is synonymous with the definition of the insert being wholly composed of the same contiguous material throughout its periphery. The inventor and author recognizes that a substitution conforming to existing manufacturing processes may be unavoidable in some circumstances due to limitations of technical processes and ultimately the cost of production to retail cost to the end-user. For example, the use of non-continuous malleable or resilient and deformable elements, although not as efficacious, may be considered in limited isolation cases where cost to the end-user is of paramount concern. Another possible modification due to limitation of manufacturing processes is the use of parallel wires of circular, square, rectangular, or other cross-sectional form which are imbedded in an extrusion process which coats them and links them together rigidly or semi-rigidly with a web of disparate material such as metal foil, plastic, paper, polymeric material, composite, or other material. This manufacturing process forms a type of wide tape which is then die cut internally and externally, forming essentially an oval or rectangular form, leaving the malleable wires, but with enough material to impart rigidity or semi-rigidity in order to simulate the action of operative inserts which have the full continuous wire loops or continuous oval metal stampings. This analogous operative insert might be coated with an adhesive of many different kinds, with or without a peel strip, and either be applied as separate inserts in the field assembly method of the general field isolation rubber dam, or may be adhered or bonded directly to a rubber dam membrane as a slightly altered embodiment of the general field isolation rubber dam. Further, this process could be applied to any of the inserts;

whether elastic, malleable, resilient and deformable, or rigid. The end result would be a moldable operative perimeter, which would be applied in precisely the same way as the full continuous operative inserts, and should be considered to be filly within the spirit and scope of this patent disclosure.

The highest level of cross sectional form of an operative insert is one which allows the operative perimeter to be molded three-dimensionally in any direction by the end user, and one which lacks any dimensional eccentricity which may cause it to twist or deform when external tensile forces are applied to it by the stretching of the rubber dam material or by muscular movements and stresses subject to it by the patient. For this reason, the author believes that some cross sectional forms such as circular, square, pentagonal, septagonal, heptagonal, octagonal, or other relatively directionally uniform forms are more efficacious than elliptical, or oval, or rectangular forms. The author is aware that substitutions and compromises must sometimes be made, subject to restrictions inherent in the manufacturing process. In some cases, an elliptical or oval or rectangular cross-sectional form may be acceptable, but the definition of what is truly acceptable and what compromises the application to the point of defeating the final performance of the product is one of degree and judgment. The general rule of thumb that should be applied is that there is an inverse relationship between the degree of eccentricity of the cross-sectional form of an operative insert and its efficacy as a moldable perimeter. Hence, a rectangular cross-sectional form with a ratio of width to height of 2:1 or 3:1 or 4:1 is far more acceptable than a rectangular cross sectional form of 20:1 or 40:1 or 60:1. An example of an unacceptable cross sectional form is the ‘tape’ like form of the Cofferdam intra-arch dam, which surely approximates a 20:1 or 30:1 ratio. This extreme eccentricity of cross sectional form not only limits deflection of the element in only one dimension, but also allows tensile forces applied to it by the stretched rubber dam material to be multiplied by the physical principles of angular momentum, causing the element to bend, twist, and distort with externally applied tensile forces. An example of an acceptable rectangular cross-sectional form being accepted as a compromise due to manufacturing requirements is that of an operative insert which is formed by a die-cutting, or stamping, or ‘blanking’ process, where the width of the material must be greater than its thickness in order to prevent the material from bending and distorting during the stamping process. In this case, a width of 2:1 or 3:1 is absolutely minimal, and must be increased as the degree of malleability of material increases. In addition, the material handling requirements of inserting the operative insert into the rubber dam membrane further contributes to the variables associated with production processes. A ratio of 5:1 to 6:1 and even higher is still within consideration, particularly if the material is highly malleable. A ‘hard and fast rule of thumb’ is not possible to apply to this circumstance, but must be ascertained by a consideration of all the variables of manufacturing, metallurgy, and cost of manufacturing. It should be emphasized that a simple change of cross-sectional form of the operative inserts described in this disclosure should not be considered a change in novelty of these devices, but should be considered to be within the spirit and scope of this disclosure.

The highest forms of operational shapes of operative inserts are the arch forms and partial arch forms presented, which are anatomically homologous to human anatomy. The final forms are based on variations of human anatomy presented in the population. In addition, designs for whole arch, ¾ arch, ½ arch, quadrant, segment, and other sections of the human alveolar arch are based on a knowledge of the variants of form required for the clinical isolation needs of the practicing dentist. The author recognizes again, that due to limitations of manufacturing processes, some departure from the ideal may be made, and still be efficacious. In the case of the malleable and resilient and deformable inserts, the end-user has ultimate control over the final form imparted to the operative inserts, by virtue of their malleability. The qualities which make the operative inserts so adaptable and so moldable, also allow for compensatory correction from departures from ideal design form due to manufacturing limitations. An example of a departure from anatomic form for an operative insert is the unilateral resilient and deformable operative insert for segmental use. This particular insert might be manufactured as a long rectangular shape with rounded corners of contiguous material or two parallel wires linked at the ends by rigid or semi-rigid connectors of arcuate form. The parallel sides of the insert, not being anatomically accurate, might be dimensionally wider than is necessary, to compensate for some curvature of the arch. Bending of the resilient and deformable insert by the end-user, allows the manufactured form to be adapted to anatomic form, and in so doing is a further form of compensatory mechanism to make up for manufacturing compromises. Bending of the ends of the insert to form the transverse arch, will not affect or be affected by the use of a disparate material serving as an end connector. The final goal of achieving transverse arches, a labial bow, and a lingual bow may still be achieved. The introduction of somewhat non-anatomic forms of operative inserts to accommodate manufacturing processes or the introduction of operative inserts with disparate rigid or semi-rigid materials which have similar physical handling characteristics to materials already inherent in the operative insert, and fulfilling the same operational and functional characteristics as either the elastic, malleable, resilient and deformable, or rigid operative inserts should be considered as falling within the spirit and scope of this disclosure and should not be considered a change of novelty.

It needs to be recognized that while this series of field isolation operative inserts are generally arch shaped, requiring the ends to be bent at a 45 degree angle in order to create the elements of transverse arches, labial bow, and lingual bow, there are other flat form shapes which would lend themselves to bending and forming to achieve roughly the same elements of a three dimensional operative perimeter. For example, if two opposing sides of a square or rectangular flat form are bent in a generally arcuate manner, creating the form of two transverse arches, the resultant three dimensional form approaches the final form previously described as the four elements of an operative perimeter. The 90 degree right angles become the equivalent of the angles formed when bending the ends of the arch forms of the preferred embodiment of this disclosure. If an oval or elliptical flat form is bent in a similar manner, creating opposing arcuate forms, the resultant form is roughly equivalent to the four elements of transverse arches and labial and lingual bows. In this case, the labial and lingual bows are not straight, as they are when a square or rectangle is bent, but rather are somewhat curved. In addition, there are no definitive angular angles formed between transverse arches and the bows, but rather these elements blend together in an arc. In summary, there arte different forms which can arrive to achieve roughly the same result as is described in this disclosure. Any such alterations or substitutions should be considered to be within the spirit and scope of this disclosure and not a change of novelty.

The rubber dam membranes outlined in this disclosure are generally unidirectional membranes; that is, they have both a tissue contact side and another side which is directed away from contact with the teeth and gingival tissues. Also, the operative inserts are either integrally integrated or attached in a manner which favors one side. This unidirectional design is arbitrary. Any alternative design which allows the membranes to be used bi-directionally, or on either side, should be considered to be within the spirit and scope of this disclosure, and not a change of novelty.

All changes to embodiment associated with manufacturing limitations and constraints discussed apply to the operative inserts which are produced as separate devices for field assembly of general field isolation rubber dams as well as field isolation rubber dams with integral operative inserts. Any or all changes to embodiment due to manufacturing constraints apply equally to these operative inserts, whether they are of malleable composition, or resilient and deformable operative inserts for inter-arch applications, or rigid, pre-formed operative inserts with elements of transverse arches, labial, and lingual bows already formed in the manufacturing process. An example of a slight change in embodiment of the separate operative inserts due to a manufacturing constraint might be the manufacture of either the malleable or the elongated resilient and deformable operative inserts as detachable elements of a type of tape-like processes. Instead of perfect arch forms at the ends, a flat abutting end of successive inserts which could be detachably separated might be substituted. Each insert would be detached like a theater ticket, and applied to a rubber dam in the Field isolation method of construction of a field isolation or modified conventional rubber dam. The end of the insert subsequently, might be an octagonal or even a square form. In addition, two parallel wires, attached by a semi-rigid or rigid transverse element might be a further departure from the ideal insert made wholly of like material. Any changes to embodiment due to limitations of manufacturing processes, or of short-cuts which may be produced more inexpensively than the full embodiments, shall still be considered to be within the spirit and scope of this patent disclosure. Some injection molding processes allow for the manufacture of complex forms that stamping, bending, forming, die casting, and other manufacturing processes do not. It is for this reason that a whole classification of the devices described within this disclosure which are injection molded of plastic or composite or other resilient or resilient and deformable material must be considered as part of the spirit and scope of this disclosure. These devices most likely would be fabricated on three dimensional molds or dies as field isolation rubber dams or as separate operative inserts with the pre-set elements of transverse arches, labial bows, and lingual bows, and accomplish essentially the same function as the other rubber dam devices described in this disclosure. Although these devices would be classified as having rigid, pre-set operative inserts, their plastic or composite material might act in a somewhat resilient manner within the parameters of its elastic limit, thereby imparting a practical quality of resiliency to the device clinically. All such devices under this classification of being ‘rigid’, having the pre-set elements of transverse arches, labial, and lingual bows, should be considered as being within the spirit and scope of this disclosure.

Although the invention has been described with respect to a preferred embodiment thereof, it is to be also understood that it is not to be so limited since changes and modifications can be made therein which are within the full intended scope of this invention as defined by the appended claims.

I claim:

1. A rubber dam comprising a sheet of elastomeric material and an operative insert engaged to the sheet of elastomeric material.

2. A rubber dam as defined in claim 1, wherein the operative insert is enclosed in the elastomeric material.

3. A rubber dam as defined in claim 1, wherein the operative insert is elastomeric.

4. A rubber dam as defined in claim 1, wherein the operative insert is malleable to a plurality of adjusted, three-dimensional shapes.

5. A rubber dam as defined in claim 4, wherein the operative insert comprises a material selected from the group comprising metal wire, metal stamping, die cast metal, die-cut metal, and memory-retaining plastics and composites.

6. A rubber dam as defined in claim 1, wherein the operative insert is resilient.

7. A rubber dam as defined in claim 1, wherein the operative insert is substantially rigid.

8. A rubber dam as defined in claim 1, wherein the operative insert comprises a closed loop which divides the sheet into a region exteriorly of the operative insert and a region interiorly of the operative insert.

9. A rubber dam as defined in claim 8, further comprising an opening in the elastomeric material inside the closed loop.

10. A rubber dam as defined in claim 9, wherein a mesh material encircles the periphery of the opening to provide a bonding surface for releasable securement of the mesh material to areas near the site of a medical procedure.

11. A rubber dam as defined in claim 9, wherein the elastomeric material encircles the periphery of the opening forming a flange extended inwardly of the operative insert.

12. A rubber dam as defined in claim 11, wherein an adhesive is applied to the flange.

13. A rubber dam as defined in claim 1, wherein the operative insert is integrally attached to a surface of the elastomeric material.

14. A rubber dam comprising a sheet of elastomeric material in which is embedded a sheet of malleable material which is hand-adjustable to a plurality of retained three-dimensional shapes.

15. A rubber dam as defined in claim 14, wherein the sheet of malleable material is a continuous sheet.

16. A rubber dam as defined in claim 14, wherein the sheet of malleable material is a discontinuous sheet.

17. A rubber dam as defined in claim 14, further comprising an opening in the elastomeric sheet and the malleable sheet for isolation of a site of a medical procedure.

18. A rubber dam, comprising a sheet of elastomeric material and an operative insert engaged to the sheet of elastomeric material which resists the transmission of tensile forces in the elastomeric material on a first side of the operative insert from being transmitted to the elastomeric material on an opposite side of the operative insert.

19. A rubber dam as defined in claim 18, wherein the operative insert is a closed loop.

20. A rubber dam as defined in claim 18, wherein the operative insert comprises one or more discontinuous elements that do not form a closed loop.

21. A rubber dam for use in isolating the field of a dental procedure, comprising:
(a) a sheet of elastomeric material;
(b) an operative insert engaged to the sheet;
(c) an opening in the elastomeric material through which the dental procedure will be performed; and
(c) wherein the operative element is malleable and deformed by hand manipulation to create, a lingual bow, a facial bow, and a pair of linking transverse arches which correspond to the anatomical contours adjacent the field and assists in positioning the opening around the field.

22. A rubber dam as defined in claim 6 for isolating the field of a dental procedure in the mouth of a patient having an upper dental ridge and a lower dental ridge, further comprising an opening in the sheet through which the dental procedure will be performed, and wherein the resilient operative insert is shaped by adjustment beyond its elastic limit to provide a lingual bow, a facial bow, and a pair of linking transverse arches, one of which spans the upper ridge and the other of which spans the lower ridge, whereby reciprocal interarch forces against the resilient operative insert assist in retaining the opening around the field.

23. A rubber dam as defined in claim 22, wherein the resilient operative insert assists in propping open the mouth by resiliently resisting the musculature of the patient attempting to close the mouth.

24. A rubber dam as defined in claim 8 for isolating the field of a dental procedure, further comprising an opening in the sheet in the region interiorly of the operative insert and through which the dental procedure will be performed, and wherein the operative insert comprises elastomeric material which disperses the forces of the sheet present exteriorly of the operative insert so as to limit stretching and tearing of the sheet interiorly of the operative insert.

25. A rubber dam assembled at the time of use, comprising a sheet of elastomeric material, a separate operative insert, and means for securing the operative insert to the sheet of elastomeric material.

26. A rubber dam as defined in claim 25, wherein the operative insert is comprised of materials having a property selected from the group consisting of elastic, malleable, resilient, and rigid.

27. A rubber dam for isolating the field of a dental procedure in the mouth of a patient having an upper dental arch and a lower dental arch, comprising:
(a) a sheet of elastomeric material;
(b) a resilient operative insert engaged to the sheet and having a pre-formed shape comprising a full lower facial bow and a full lower lingual bow that are linked to a full upper facial bow and a full upper lingual bow at a resting angle larger than the fill open angle between the upper and lower dental arches of the patient;
(c) at least one opening in the sheet of elastomeric material between a lingual bow and a corresponding facial bow through which the dental procedure will be performed; and
(d) the resilient operative insert is flexed below the resting angle to permit its insertion into the mouth of the patient with the upper dental arch positioned between the upper lingual bow and the upper facial bow and the lower dental arch positioned between the lower lingual bow and the lower facial bow and the opening poisoned around the field, whereby reciprocal interarch forces against the resilient operative insert assist in retaining the opening around the field.

28. A method of isolating a field of a medical procedure, comprising the steps of:
(a) manually adjusting the shape of the operative insert of a rubber dam of claim 1 to conform to three-dimensional anatomical contours adjacent the field;
(b) creating an opening in the sheet of elastomeric material through which the medical procedure will be performed;
(c) positioning the rubber dam with the opening around the field; and
(d) releasably retaining the rubber dam in position.

29. A method as defined in claim 28 wherein the medical procedure is a dental procedure to be performed in the mouth of a patient having a dental ridge, wherein: the shape of the operative insert is manually adjusted to create a lingual bow, a facial bow, and a pair of linking transverse arches; and the rubber dam is positioned with the opening around the field, the lingual bow on the lingual side of the field, the facial bow on the facial side of the field and the transverse arches spanning the dental ridge.

30. The method as defined in claim 29, wherein a dental clamp is used to assist in releasably retaining the rubber dam in position.

31. The method as defined in claim 29, wherein an adhesive is used to assist in releasably retaining the rubber dam in position.
